(19) United States
(12) Patent Application Publication
(10) Pub. No.: US 2007/0058287 A1
(43) Pub. Date: Mar. 15, 2007

(54) Media cartridge autoloader

(76) Inventors: Kenichi Hori, Tokyo (JP); Hiromi Tanaka, Tokyo (JP)

Correspondence Address: ANDERSON KILL & OLICK, P.C., 1251 Avenue of the Americas, New York, NY, 10020, US

(21) Appl. No.: 11/286,164

(22) Filed: Nov. 22, 2005

(30) Foreign Application Priority Data
Sep. 15, 2005 (JP) 2005-269197

(51) Int. Cl. G11B 15/68

(52) U.S. Cl. 360/92

(57) ABSTRACT

The present invention discloses a media cartridge autoloader for transporting a media cartridge container to a predetermined media cartridge retrieval position, retrieving a media cartridge stored in the media cartridge container from an opening of the media cartridge container, and reading and/or writing data from or to the media cartridge. The media cartridge autoloader includes a latching part for latching the media cartridge to a predetermined storage position inside the media cartridge container, and a protrusion for returning the media cartridge to the latched state in the predetermined storage position when the media cartridge protrudes from the opening of the media cartridge container.

### BACKGROUND OF THE INVENTION

1. Field of the Invention

The present invention relates to a media cartridge autoloader, and particularly relates to a media cartridge autoloader configured to transport plural media cartridge containers having a media cartridge inserted therein and allow a given media cartridge to be retrieved therefrom.

2. Description of the Related Art

A typical media cartridge autoloader includes a media cartridge picker, a mail slot, a media drive, and a plurality of media cartridge transport magazines. The media cartridge picker is configured to transport a media cartridge among the mail slot, the media drive, and the media cartridge transport magazines.

The media cartridge transport magazines each comprises a plurality of media cartridge storage cases along a loop belt so as to store the media cartridges therein. The loop belt is driven such that a selected one of the media cartridge storage cases is moved next to the media cartridge picker.

To store many media cartridges, the media cartridge transport magazines can be positioned one at each side of the media cartridge picker. The media cartridge transport magazine includes plural media cartridge containers into which a media cartridge(s) is inserted. In mounting the media cartridge to the read/write media drive, a designated media cartridge is retrieved by driving the belt and moving the media cartridge containers.

In the above-described media cartridge autoloader, the media cartridge in the media cartridge container is stored in an easily movable state so as to reduce resistance when retrieving the media cartridge from the media cartridge container. Therefore, when shock is applied from the outside, the shock may cause the media cartridge to protrude from an opening of the media cartridge container and contact a lateral plate or other structures of the media cartridge transport magazine facing the path through which the media cartridge container is transported.

### SUMMARY OF THE INVENTION

The present invention is directed toward a media cartridge autoloader for transporting a media cartridge container to a predetermined media cartridge retrieval position, retrieving a media cartridge stored in the media cartridge container from an opening of the media cartridge container, and reading/writing data from or to the media cartridge, the media cartridge autoloader including: a latching part for latching the media cartridge to a predetermined storage position inside the media cartridge container; and a protrusion for returning the media cartridge to the latched state in the predetermined storage position when the media cartridge protrudes from the opening of the media cartridge container.

### BRIEF DESCRIPTION OF THE DRAWINGS

FIG. 1 is a perspective view illustrating a media cartridge autoloader with an upper cover thereof removed according to a first embodiment of the present invention;

FIG. 2 is a side view illustrating the media cartridge autoloader of FIG. 1 with a side cover thereof removed;

FIG. 3 is a schematic illustration showing operations of a media cartridge picker;

FIG. 4 is a perspective view illustrating a main module;

FIG. 5 is an exploded view illustrating the main module;

FIG. 6 is a perspective view of the main module, viewed from a Y1 side;

FIG. 7 is a perspective view illustrating the media cartridge picker;

FIG. 8 is a perspective view illustrating the media cartridge picker with a pillar and a turntable removed;

FIG. 9 is an exploded perspective view illustrating the media cartridge picker;

FIG. 10 is an exploded perspective view illustrating a turntable lifting mechanism in detail;

FIG. 11 is a perspective view illustrating the turntable;

FIG. 12 is a schematic illustration showing a media cartridge transport mechanism;

FIG. 13 is a perspective view of the main module with the cartridge picker, a mail slot module, and a motor module removed, viewed from a Y2 side;

FIG. 14 is a perspective view of the main module of FIG. 13, viewed from the Y1 side;

FIG. 15 is a perspective view of a Y2-side part of the main module with the mail slot module removed, viewed obliquely from an X2 side;

FIG. 16 is a perspective view illustrating a magazine drive with a drive shaft unit located at a home position;

FIG. 17 is a perspective view showing an X1-side portion of the Y2-side part of the main module with the mail slot module removed;

FIG. 18 is a perspective view of the Y2-side part of the main module, viewed obliquely from an X1 side;

FIG. 19 is an enlarged perspective view showing a drive gear and a positioning pin disposed at the X2 side;

FIG. 20 shows a photo sensor for detecting the rotation angle of the turntable;

FIG. 21 is a perspective view of the media cartridge transport magazine with an X2-side lateral plate removed, viewed from the X2 side;

FIG. 22 is a perspective view of the media cartridge transport magazine of FIG. 21, viewed from the X1 side;

FIG. 23 is an enlarged view illustrating a part of the media cartridge transport magazine of FIG. 22;

FIG. 24A illustrates the media cartridge transport magazine drive in its initial state;

FIG. 24B illustrates the media cartridge transport magazine drive in a state to drive an X2-side magazine;

FIG. 24C illustrates the media cartridge transport magazine drive in a state to drive an X1-side magazine;

FIG. 25 illustrates an X2-side part of the drive shaft unit opposing a magazine in the initial state;

FIG. 26 illustrates the X2-side part of the drive shaft unit in a process of being coupled with the magazine;

FIG. 27 illustrates the X2-side part of the drive shaft unit coupled with the magazine;

FIG. 28 illustrates operations for correcting a center distance between the drive gear and the magazine gear;

FIGS. 29A-29D illustrate operations to be performed when tooth sections of the drive gear contact and interfere with tooth sections of the magazine gear;

FIG. 30 is a flowchart illustrating operations of a microcomputer of a motor control circuit;

FIGS. 31A-31C illustrate a media cartridge container 401, in which FIG. 31A is a plane view thereof, FIG. 31B is a front view thereof, and FIG. 31C is a side view thereof;

FIG. 32 is a perspective view of the media cartridge container 401;

FIG. 33 is a partly cutaway plane view of the media cartridge container 401 in a state having a media cartridge 10 stored in a cartridge storage space 405;

FIG. 34 is a partly cutaway plane view of the media cartridge container 401 in a state having the media cartridge 10 separated from cartridge storage space 405;

FIG. 35 is a perspective view of a container transport mechanism 430;

FIG. 36 is a perspective view of a container guide mechanism 440;

FIG. 37 is an illustration showing plural media cartridge containers 401 coupled to a timing belt 400 via corresponding belt coupling members 432;

FIGS. 38A-38B is an enlarged view illustrating an attachment structure of the belt coupling member 432, in which FIG. 38A is a front view thereof and FIG. 38B is a side view thereof;

FIG. 39 illustrates an operation state prior to the engagement between a pulley 386Y1 and the belt coupling member 432;

FIG. 40 illustrates an operation state where the pulley 386Y1 and the belt coupling member 432 are engaged;

FIG. 41 illustrates a state where the belt coupling member 432 is rotated 90 degrees while being engaged to the pulley 386Y1;

FIG. 42 is a perspective view showing a portion of a configuration of a lateral plate 403; and

FIG. 43 is a plan view showing a state of the media cartridge container 401 immediately before a lowering operation.

### DETAILED DESCRIPTION OF THE PREFERRED EMBODIMENT

An exemplary embodiment of the present invention is described hereinafter with reference to the accompanying drawings.

### First Embodiment

The description of a first embodiment includes the following:

1 Configuration and Operations Overview of Tape Cartridge Autoloader 100

2. Configuration of Main Module 110

3. Configuration and Operations of Tape Cartridge Picker 102

4. Configuration of Tape Cartridge Transport Magazine Drive 300
4-1. Configuration of Drive Shaft Unit 301
4-2. Configuration of Drive Shaft Unit Shift Mechanism 320
4-3. Configuration of Magazine Drive Motor Module 330

5. Configuration of Tape Cartridge Transport Magazines 103, 104

6. Operations for Selectively Driving Tape Cartridge Transport Magazines 103, 104

7. Operations of Microcomputer of Motor Control Circuit 410

8. Transport Mechanism for Tape Cartridge Container 401

1 [Configuration and Operations Overview of Tape Cartridge Autoloader 100]

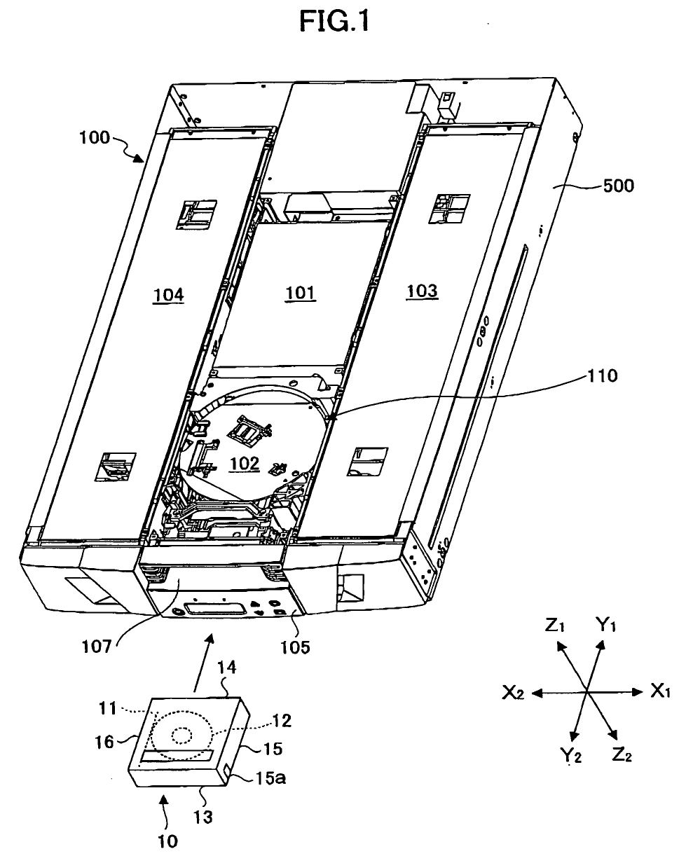

FIG. 1 is a perspective view illustrating a media cartridge autoloader 100 with an upper cover thereof removed according to the first embodiment of the present invention. In the embodiments illustrated in the figures, the media cartridge autoloader is used with one or more tape cartridges, and is therefore referred to as a tape cartridge autoloader. It is recognized, however, that although the following description and the figures provided herein pertain particularly to an autoloader used for tape cartridges, any other suitable type of media cartridge can equally be used with the present invention, such as an optical disk cartridge, as one non-exclusive example. The embodiments disclosed herein are not intended to limit the scope of the present invention in any manner to use with tape cartridges or any other particular type of media, In other words, it is understood that the term “tape” as used herein can equally be substituted for the term “media”.

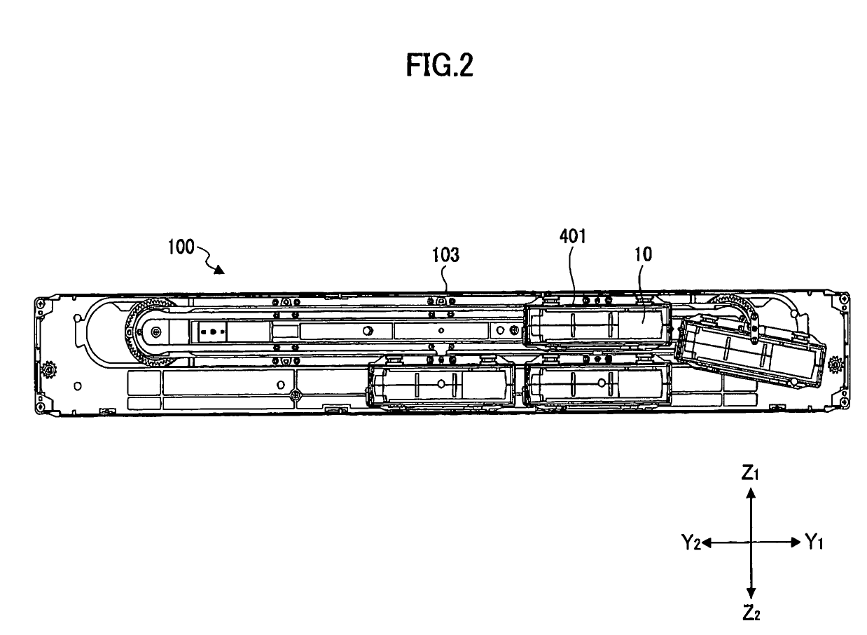

FIG. 2 is a side view illustrating the tape cartridge autoloader 100 with a side cover thereof removed. Throughout the drawings, the width direction is indicated by a line X1-X2, the depth direction is indicated by a line Y1-Y2, and the height direction is indicated by a line Z1-Z2.

In one embodiment, the tape cartridge autoloader 100 generally comprises a metal frame 500, a control panel 105 and a mail slot 107 both on a front panel, a main module 110 including a tape cartridge picker 102 at a position opposing the mail slot 107, a tape drive 101 disposed at the Y1 side of the main module 110, and first and second tape cartridge transport magazines 103 and 104 disposed one at the X1 side and the X2 side of the main module 110. The tape cartridge transport magazines 103 and 104 can be inserted toward the Y1 side from the front panel side and removably attached on opposing sides of the frame 500. It is understood that either tape cartridge transport magazine 103, 104 can be the first tape cartridge transport magazine or the second tape cartridge transport magazine. The tape cartridge autoloader 100 can be mounted in a rack by, for example, fixing four corners of the frame 500 to poles of the rack.

In certain embodiments, the tape cartridge autoloader 100 is designed such that operations of the tape cartridge picker 102 and operations of the tape cartridge transport magazines 103 and 104 do not overlap in terms of time.

A tape cartridge 10 is used in the tape cartridge autoloader 100. Referring to FIG. 1, the tape cartridge 10 includes a magnetic tape 11 wound on a single reel 12 therein such that the magnetic tape 11 is pulled out from a rear face of the tape cartridge 10. The tape cartridge 10 includes a front face 13, a rear face 14, side faces 15 and 16, and a notch 15a formed on the side face 15 which a cartridge pin (described below) engages.

The tape cartridge transport magazines 103 and 104 are each configured to store plural tape cartridges 10 orienting the front faces 13 to face the tape cartridge picker 102. The tape cartridge transport magazines 103 and 104 are also configured to transport the tape cartridges 10 along a racetrack path elongated in the Y1-Y2 direction as shown in FIG. 2.

The tape drive 101 is operable to read and/or write data from or to the magnetic tape 11 pulled out from the loaded tape cartridge 10. The tape drive 101 includes a tape cartridge eject mechanism (not shown). Plural types of tape drives with different heights are available so that one drive is selected from them and attached to the tape cartridge autoloader 100. For this operation, the tape cartridge picker 102 is provided with a turntable lifting mechanism 150 (described below).

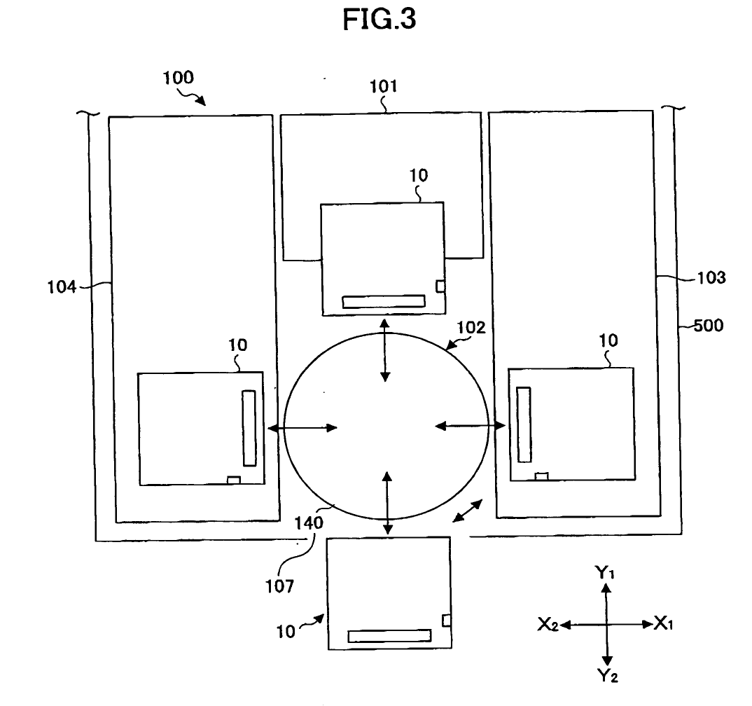

Referring to FIG. 3, the tape cartridge picker 102 is configured to transport the tape cartridge 10 onto or off of a turntable 140 for operations such as loading the tape cartridge 10 inserted through the mail slot 107 into the tape drive 101, retrieving the tape cartridge 10 from the tape cartridge transport magazines 103 and 104 to load the tape cartridge 10 onto the tape drive 101, retrieving the tape cartridge from the tape drive 101 to return the tape cartridge 10 to one of the tape cartridge transport magazines 103 and 104, and ejecting the tape cartridge 10 through the mail slot 107. The tape cartridge picker 102 is also configured to rotate the turntable 140 by a predetermined rotational increment, such as approximately every 90 degrees, for example, although the predetermined rotational increment can be varied to Suit the design requirements of the autoloader. The cartridge picker 102 can also and lift/lower the turntable 140, as necessary. When the turntable 140 is rotated, the orientation of the tape cartridge 10 is changed.

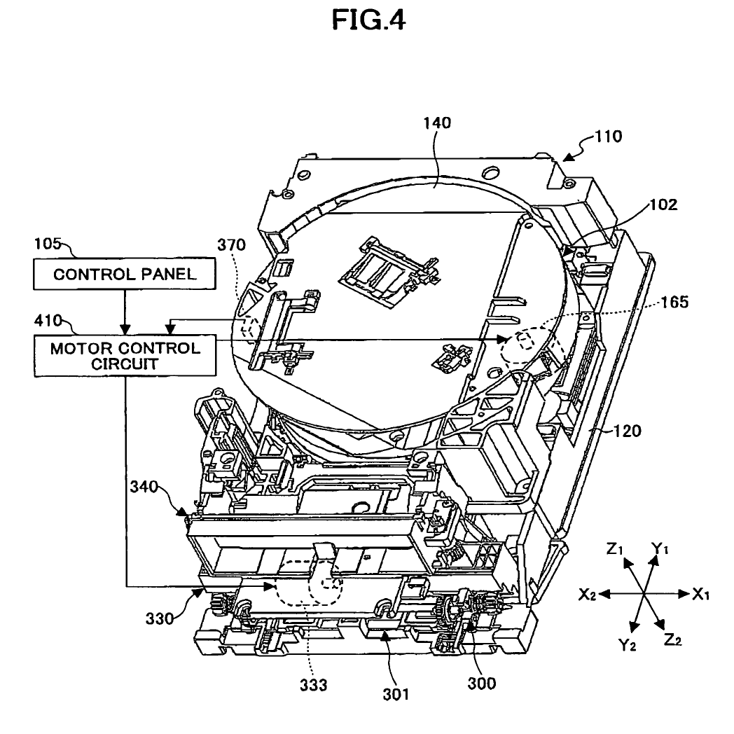

2 [Configuration of Main Module 110] (FIGS. 4-6)

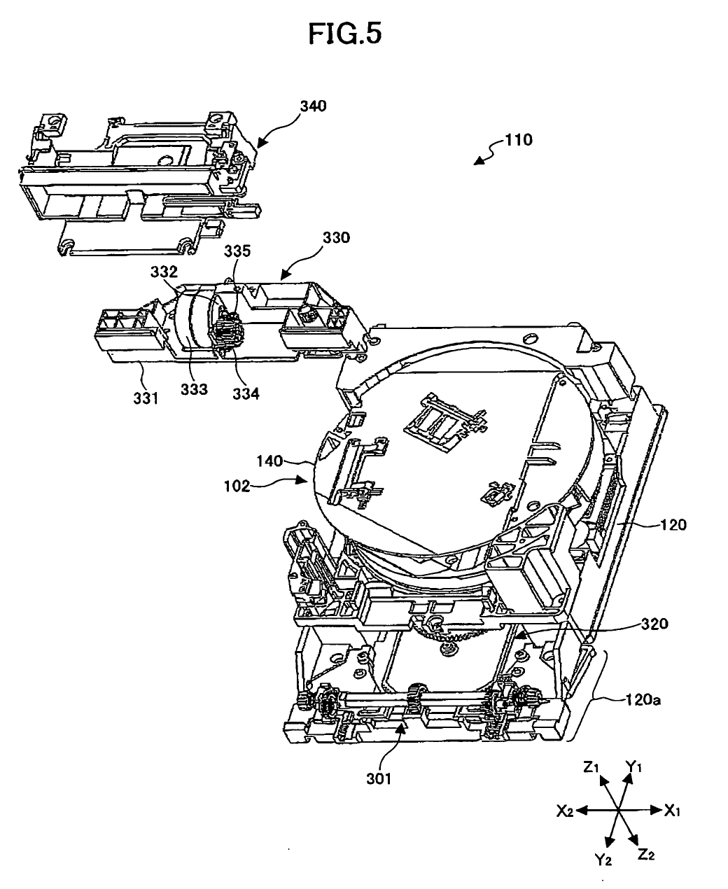

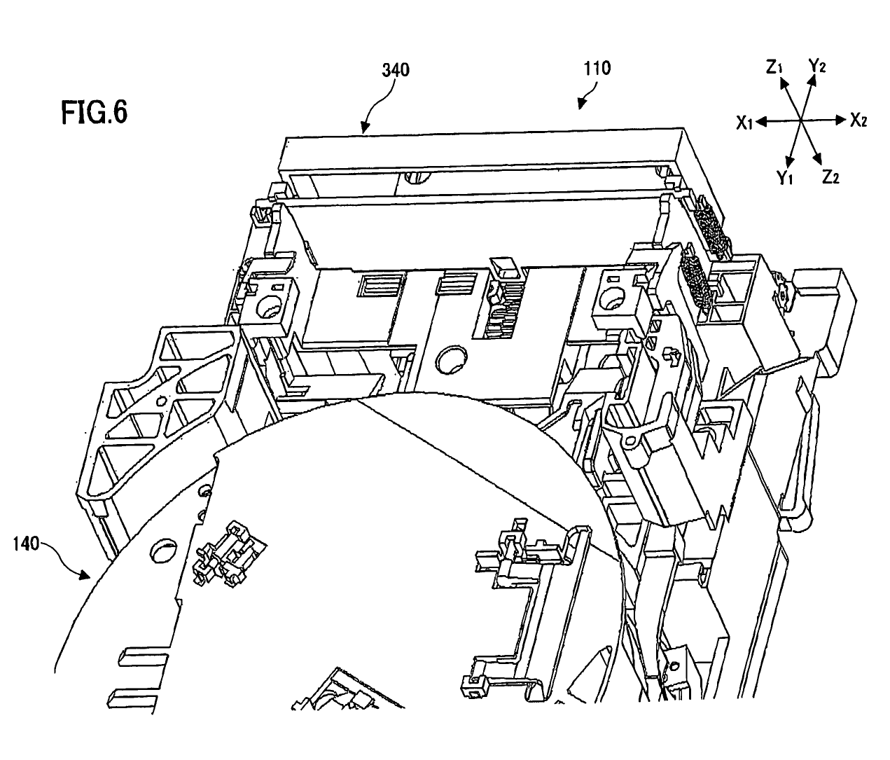

FIG. 4 is a perspective view of the main module 110. FIG. 5 is an exploded view of the main module 110. FIG. 6 is a perspective view of the main module 110, viewed from the Y1 side.

In this embodiment, the main module 110 includes a base 120. The main module 110 also includes the tape cartridge picker 102 and a tape cartridge transport magazine drive 300. The tape cartridge picker 102 can occupy a large part of the base 120. The base 120 includes an extension 120a extending at the Y2 side of the tape cartridge picker 102. A drive shaft unit 301 and a tape cartridge transport magazine drive motor module 330 are disposed on the extension 120a. For example, a mail slot module 340 can be mounted on the upper side of the magazine drive motor module 330. The magazine drive 300 comprises the drive shaft unit 301 and the magazine drive motor module 330 as described below.

A motor control circuit 410 shown in FIG. 4 drives, in response to a command generated when a user operates the control panel 105, a stepping motor 165 and a magazine drive motor 333 in a manner described below while monitoring signals from a photo sensor 370.

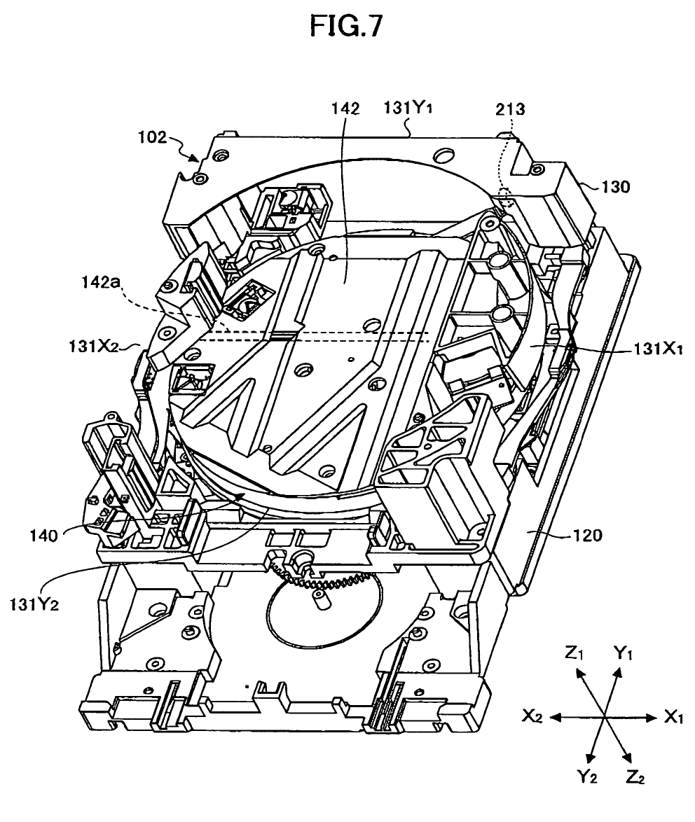

3 [Configuration and Operations of Tape Cartridge Picker 102] (FIGS. 7-12)

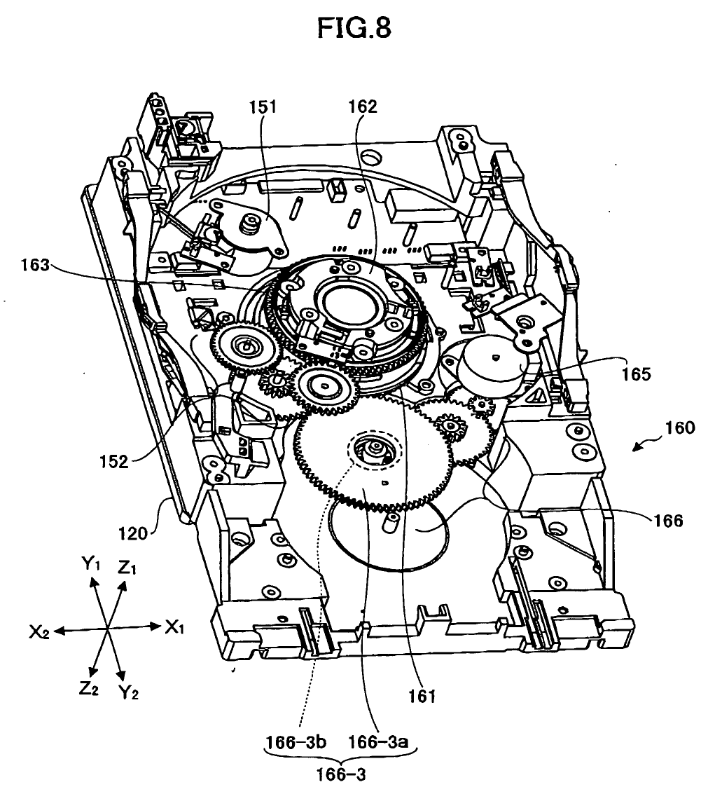

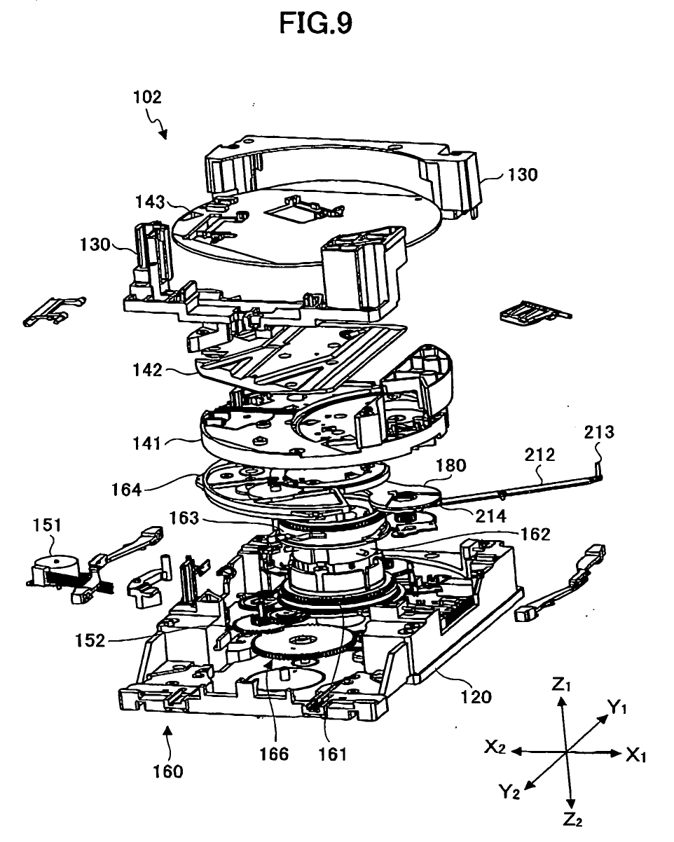

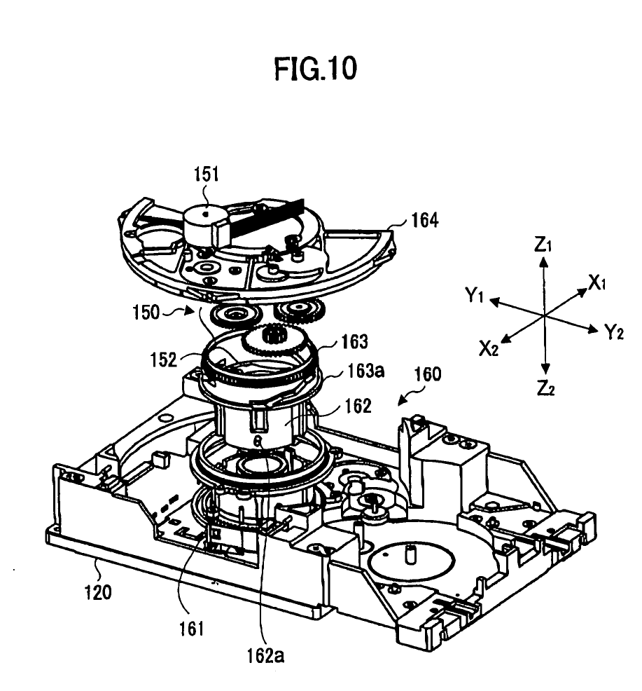

FIG. 7 illustrates the tape cartridge picker 102 with an upper plate 143 of the turntable 140 removed. FIG. 8 illustrates the tape cartridge picker 102 with a pillar 130 and the turntable 140 removed. FIG. 9 is an exploded perspective view illustrating the tape cartridge picker 102. FIG. 10 illustrates the turntable lifting mechanism 150 in detail.

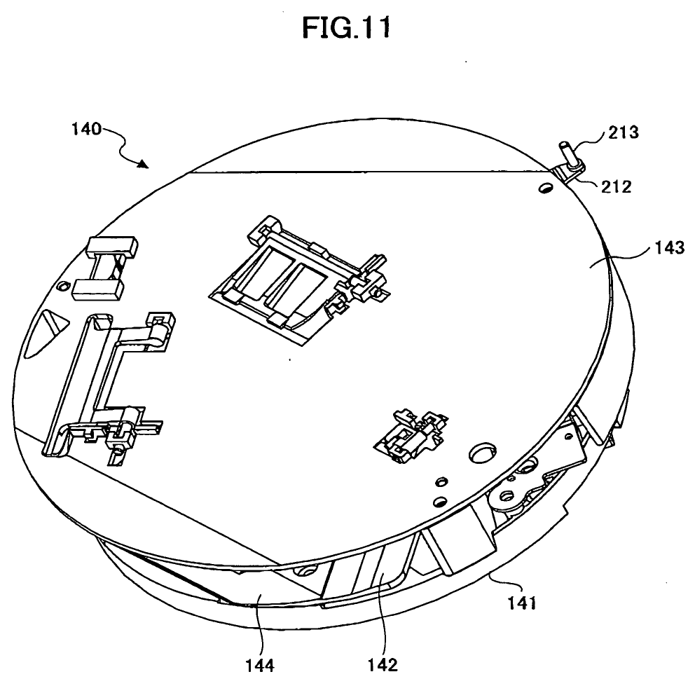

The tape cartridge picker 102 includes the pillar 130 mounted on the base 120, the turntable 140 (FIG. 11) configured to support the tape cartridge 10, the turntable lifting mechanism 150 (FIG. 10) configured to slightly lift and lower the turntable 140 for height position adjustment, and a turntable rotating mechanism 160 configured to rotate the turntable 140 at a predetermined rotational increment, such as approximately every 90 degrees, for example. The tape cartridge picker 102 has ports 131X1, 131X2, 131Y1, and 131Y2 on four sides thereof (see FIG. 7).

A rotating ring gear 161, a cylindrical stand 162, a lifting ring gear 163, and a sub base 164 are disposed on the base 120. The rotating ring gear 161 is rotatably attached on the base 120. The cylindrical stand 162 is arranged at the inner side of the rotating ring gear 161 and the lifting ring gear 163 so as to be rotated along with the rotating ring gear 161 and be lifted independently from the rotating ring gear 161. The lifting ring gear 163 is arranged at the upper side of the rotating ring gear 161 so as to be rotated independently from the rotating ring gear 161. A boss 162a (FIG. 10) of the cylindrical stand 162 is configured to engage a diagonal groove 163a of the lifting ring gear 163. The cylindrical stand 162 is rotated by rotation of the rotating ring gear 161, and lifted/lowered by rotation of the lifting ring gear 163. The sub base 164 is a semi-circular plate fixed to a position slightly separated from and at the upper side of the base 120.

Referring to FIG. 11, the turntable 140 includes a base plate 141, a floor plate 142, the upper plate 143, and a clearance 144 between the floor plate 142 and the upper plate 143 to receive the tape cartridge 10. The base plate 141 is screwed onto the cylindrical stand 162 (FIG. 10).

Referring to FIG. 10, the lifting mechanism 150 includes a stepping motor 151, a gear train 152, and the lifting ring gear 163. Both the stepping motor 151 and the gear train 152 are provided on the base plate 141.

As shown in FIG. 8, the turntable rotating mechanism 160 includes a stepping motor 165, a reduction gear train 166, and the rotating ring gear 161, all of which are provided on the sub base 164 (FIG. 9). A two-stage gear 166-3, which is the last stage gear of the reduction gear train 166, comprises a large-diameter gear section 166-3a and a small-diameter gear section 166-3b.

The lifting mechanism 150 has a function of initializing the turntable 140 by lifting/lowering the turntable 140 to a home position thereof in the Z direction. The turntable rotating mechanism 160 has a function of initializing the turntable 140 by rotating the turntable 140 to the home position in the rotation direction. The home position of the turntable 140 is a position where a y-axis (described later) becomes parallel to the Y-axis. The lifting mechanism initialization operation and the turntable rotating mechanism initialization operation apply a method of moving an object to an operation end position defined as a reference position, and then moving the object back by a predetermined distance. The same method is applied to operations for initializing a tape cartridge transport mechanism 170 (described below).

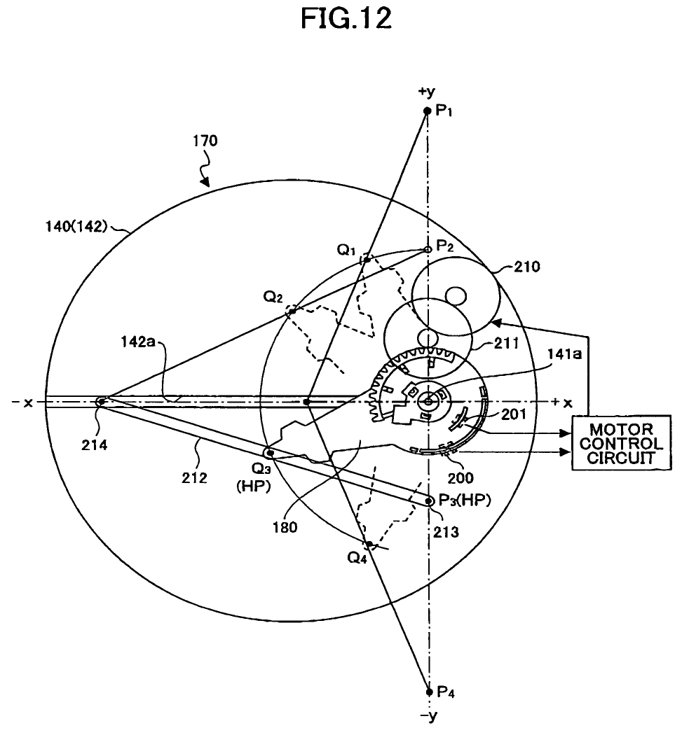

Referring to FIG. 10, the turntable 140 includes the base plate 141, the floor plate 142, the upper plate 143, and the clearance 144 between the floor plate 142 and the upper plate 143 to receive the tape cartridge 10. Referring to FIG. 12, the turntable 140 has coordinates applied wherein the position of a pin 141a (to be described below) is defined as the origin, a guide groove 142a (to be described below) is defined as an x-axis, and an axis passing through the origin and being orthogonal to the x-axis is defined as a y-axis.

The tape cartridge transport mechanism 170 and a stepping motor 210 (described later), both shown in FIG. 12, are provided on the base plate 141 (FIG. 11).

The tape cartridge transport mechanism 170 has a function of moving the tape cartridge 10 between a position on the turntable 140, i.e., a position inside the clearance 144, and a position outside the tape cartridge picker 102. In one embodiment, the transport mechanism 170 moves the tape cartridge substantially linearly. Alternatively, the transport mechanism 170 can move the tape cartridge in a non-linear manner, or using a combination of linear and non-linear movements. The tape cartridge transport mechanism 170 includes a rotary arm 180 rotatably attached to the pin 141a formed on the base plate 141, the stepping motor 210 (FIG. 12) configured to reciprocally rotate the rotary arm 180 between positions Q1 and Q4 within a predetermined angular range, a reduction gear mechanism 211 configured to transmit the rotation of the motor 210 at a reduced rotation rate to the rotary arm 180, and a lever 212 with a center part rotatably connected to a tip end of the rotary arm 180. A cartridge pin 213 is vertically fixed to an end of the lever 212, while a pin 214 is fixed to the other end of the lever 212. The pin 214 engages a guide groove 142a formed on a lower face of the floor plate 142. In one embodiment, the guide groove 142a is substantially linear. Alternatively, the guide groove 142a can be curved or otherwise non-linear.

In one embodiment, the turntable rotating mechanism 160 can rotate the turntable 140 approximately every 90 degrees, for example, in the clockwise direction or the counterclockwise direction with respect to the home position such that the orientation of the tape cartridge 10 is changed. In non-exclusive alternative embodiments, the turntable can be rotated greater than or less than 90 degrees in either direction. The tape cartridge transport mechanism 170 retrieves the tape cartridge 10 and transports it onto and off of the turntable 140 (see FIG. 3) while the cartridge pin 213 is engaged in the notch 15a of the tape cartridge 10 (FIG. 1).

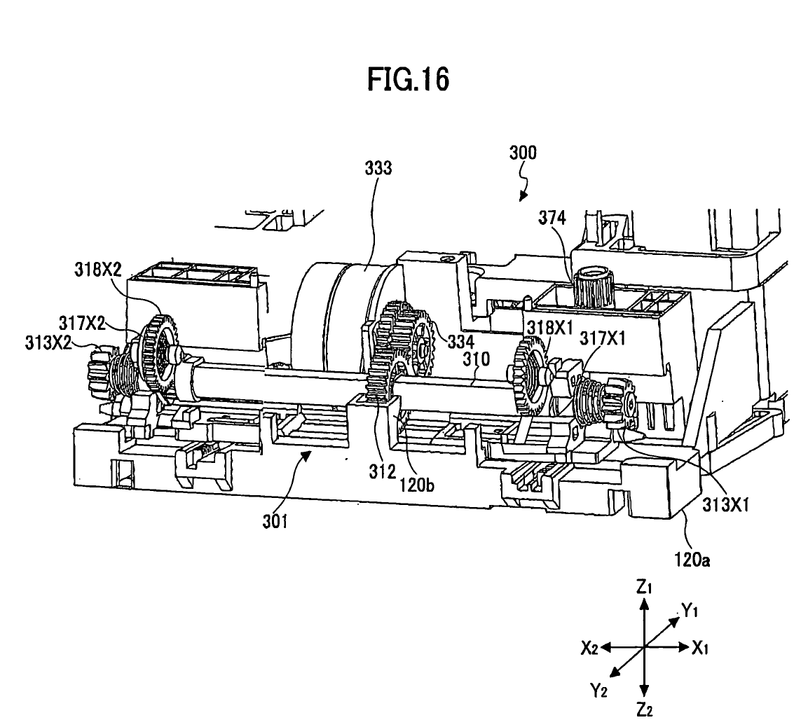

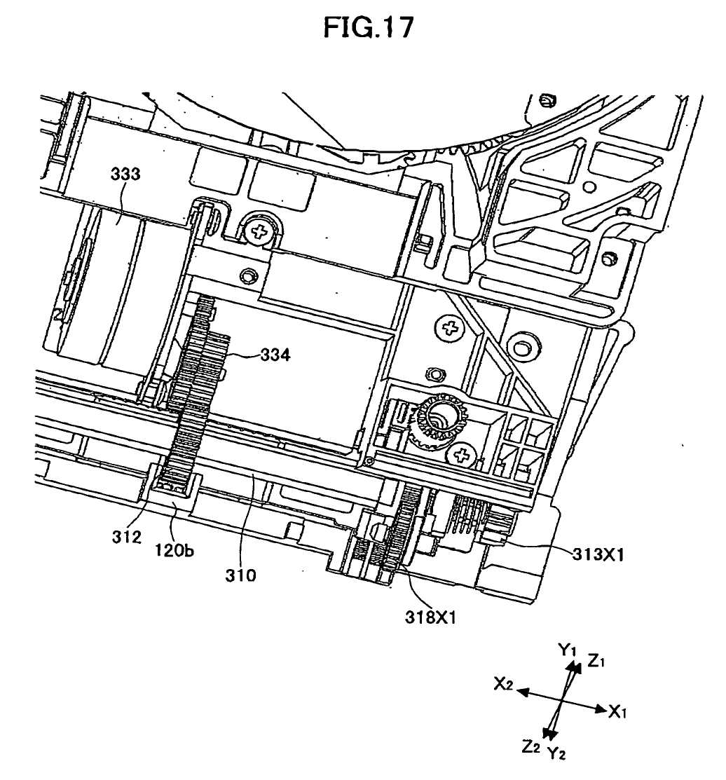

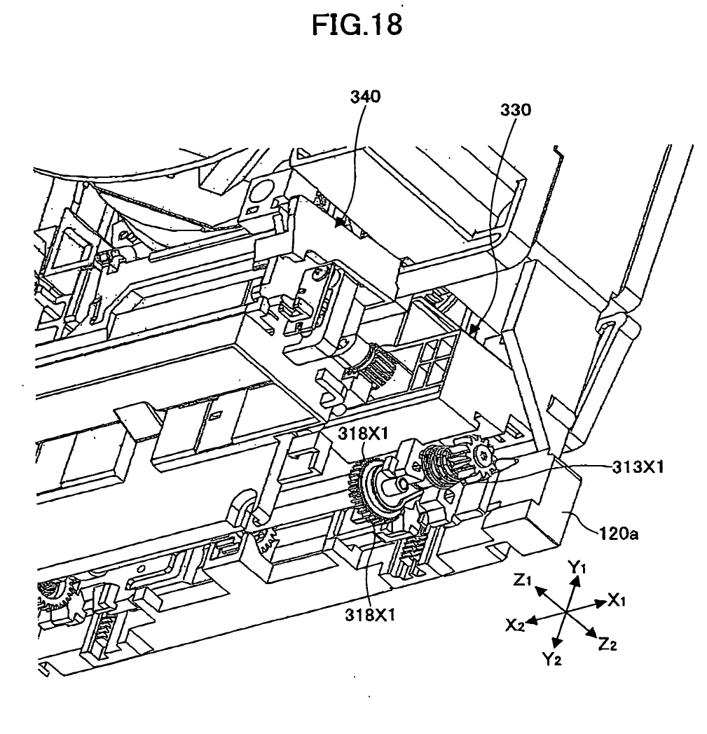

4 [Configuration of Tape Cartridge Transport Magazine Drive 300] (FIGS. 4-6, FIGS. 13-20)

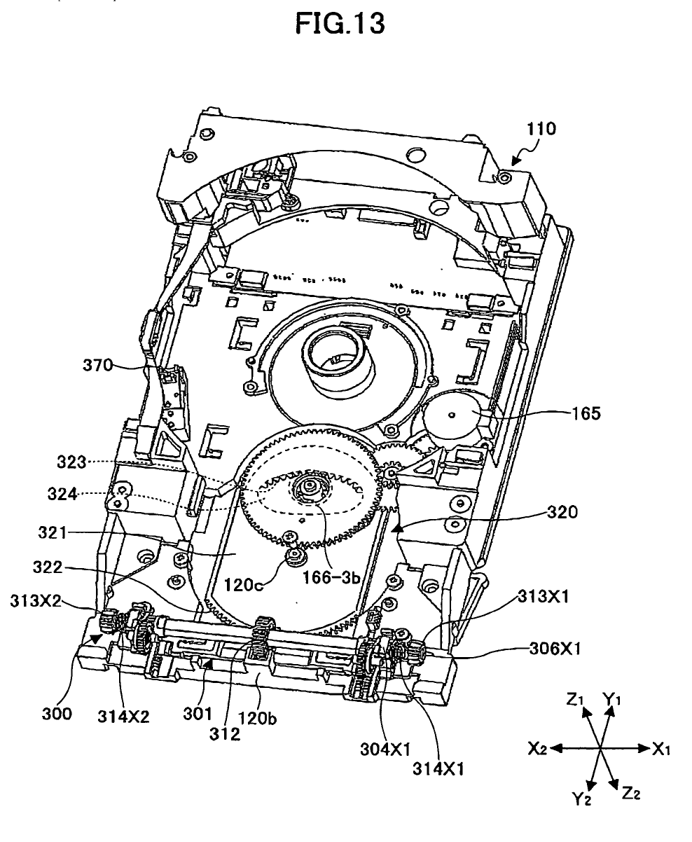

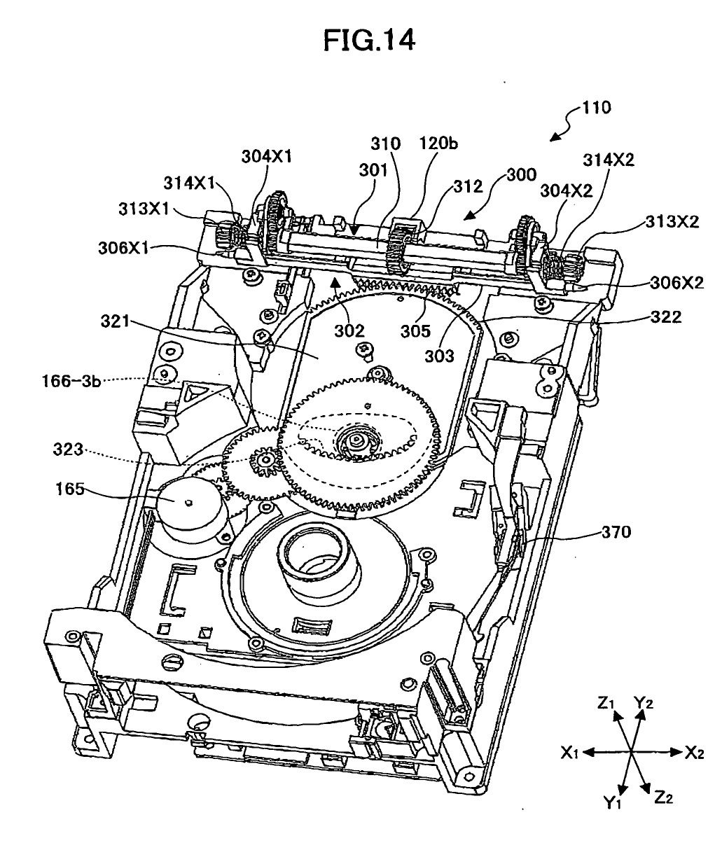

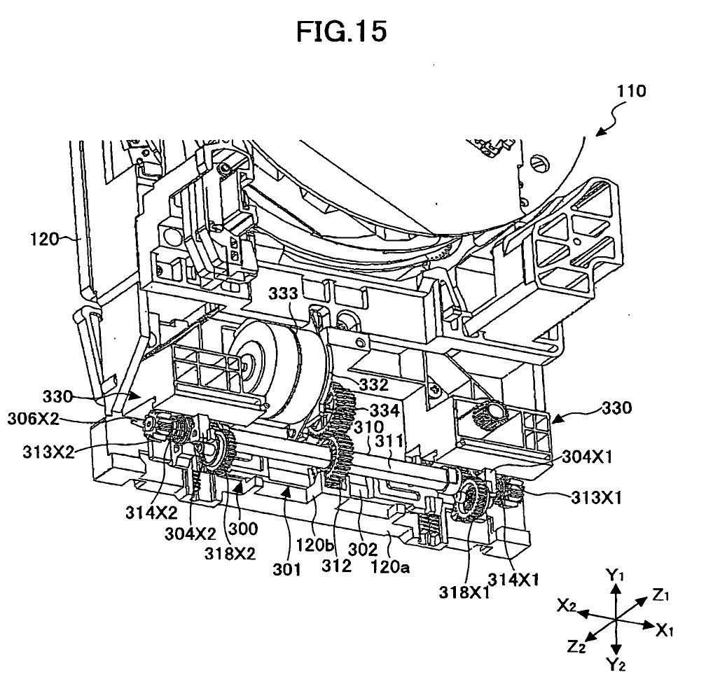

FIG. 13 is a perspective view of the main module 110 with the tape cartridge picker 102, the mail slot module 340, and the motor module 330 removed, viewed from the Y2 side. FIG. 14 is a perspective view of the main module 110 of FIG. 13, viewed from the Y1 side FIG. 15 is a perspective view of a Y2-side part of the main module 110 with the mail slot module 340 removed.

With reference to FIGS. 4, 5, and 13-15, the magazine drive 300 comprises the drive shaft unit 301, the drive shaft unit shift mechanism 320, and the magazine drive motor module 330.

4-1 [Configuration of Drive Shaft Unit 301]

Referring to FIGS. 5, 6, and 13-18, the drive shaft unit 301 comprises a frame 302, a drive shaft 310, a center gear 312, drive gears 313X1 and 313X2 disposed one on each end, and is installed on the base 120 movably in the X1-X2 direction. FIGS. 5, 6, and 13-18 show the drive shaft unit 301 located at its home position.

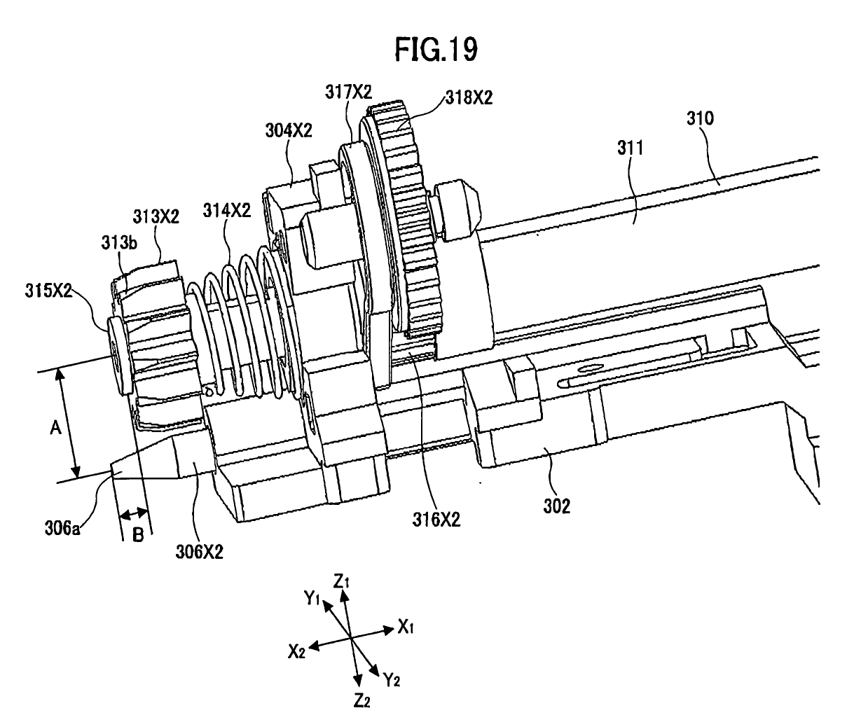

The frame 302 (FIG. 15) comprises a frame main body 303 (FIG. 14) elongated in the X1-X2 direction, flanges 304X1 and 304X2 formed one at each end of the frame main body 303, a rack 305 (FIG. 14) at the center of the frame main body 303, and positioning pins 306X1 and 306X2 provided one on each end of the frame main body 303. Each of the positioning pins 306X1 and 306X2 includes a conical section 306a (FIG. 19). The frame 302 is disposed on the extension 120a of the base 120 movably in the X1-X2 direction.

The drive shaft 310 is rotatably supported at both ends by the flanges 304X1 and 304X2. Gears 316X1 and 316X2 (FIG. 19) are secured to the drive shaft 310 at the inner side of the flanges 304X1 and 304X2. The gears 316X1 and 316X2 prevent the drive shaft 310 from moving with respect to the flanges 304X1 and 304X2 in the X1-X2 direction. The drive shaft 310 has a flat face 311 in its diametrical direction at least at the center and ends thereof so as to have a D-shaped cross section, on which the center gear 312 fits. The drive shaft 310 is configured to rotate with the center gear 312 and is movable in the X1-X2 direction with respect to the center gear 312. In one embodiment, as the center gear 312 is fitted in a holder section 120b formed integrally on the base 120, the movement of the center gear 312 in the X1-X2 direction is restricted.

The drive gears 313X1 and 313X2 are attached to the drive shaft 310 at the outer side of the flanges 304X1 and 304X2, respectively. The drive gears 313X1 and 313X2 are configured to rotate with the drive shaft 310, and are slidable along the drive shaft 310 in the axial direction of the drive shaft 310. Washers 315X2 (See FIG. 19) can be threaded on the end faces of the drive shaft 310 to prevent the drive gears 313X1 and 313X2 from dropping off. Compression coil springs 314X1 and 314X2 are wound around the drive shaft 310 between the drive gears 313X1, 313X2 and the flanges 304X1, 304X2, respectively. The drive gear 313X2 compresses the compression coil spring 314X2 to move in the X1 direction when a force in the X1 direction is applied to the drive gear 313X2. The drive gear 313X1 compresses the compression coil spring 314X1 to move in the X2 direction when a force in the X2 direction is applied to the drive gear 313X1.

As shown in detail in FIG. 19, there is a distance A between the positioning pin 306X2 and the drive shaft 310. The positioning pin 306X2 extends further outward than the drive gear 313X2 by a distance B. The drive gear 313X2 is a spur gear having a taper face 313b on the outer end. The drive gears 313X1 and the positioning pin 306X1 also have the configurations as described above.

The drive shaft unit 301 is usually located at a home (center) position shown in FIGS. 4 and 24A. When the drive shaft unit 301 is at the home position, the positioning pins 306X1 and 306X2 are located within the width of the base 120 in the X1-X2 direction.

Swing arms 317X1 and 317X2 are attached to the drive shaft 310 between the gears 316X1, 316X2 and the flanges 304X1, 304X2, respectively. Gears 318X1 and 318X2 are attached to ends of the swing arms 317X1 and 317X2. The gears 318X1 and 318X2 mesh with the gears 316X1 and 316X2, respectively. The swing arms 317X1 and 317X2 swing in the same direction as the drive shaft 310 rotates.

4-2 [Configuration of Drive Shaft Unit Shift Mechanism 320]

The drive shaft unit shift mechanism 320 utilizes the stepping motor 165 that rotates the turntable 140. The drive shaft unit shift mechanism 320 comprises the stepping motor 165 and a gear member 321 (see FIGS. 13 and 14).

The gear member 321 has a generally elliptical shape, comprising an outer gear section 322 and an inner gear section 323 along the edge of an inner opening 324. A center hole of the gear member 321 fits on a shaft portion 120c of the base 120. The inner gear section 323 engages the small-diameter gear section 166-3b, while the outer gear section 322 engages the rack 305 (FIG. 14).

When the stepping motor 165 is driven, the turntable 140 is rotated through the gear train 166. At the same time, the gear member 321 is rotated thought the small-diameter section 166-3b in the clockwise direction or the counterclockwise direction in accordance with the rotational direction of the stepping motor 165, so that the drive shaft unit 301 is moved through the rack 305 in the X2 direction or the X1 direction.

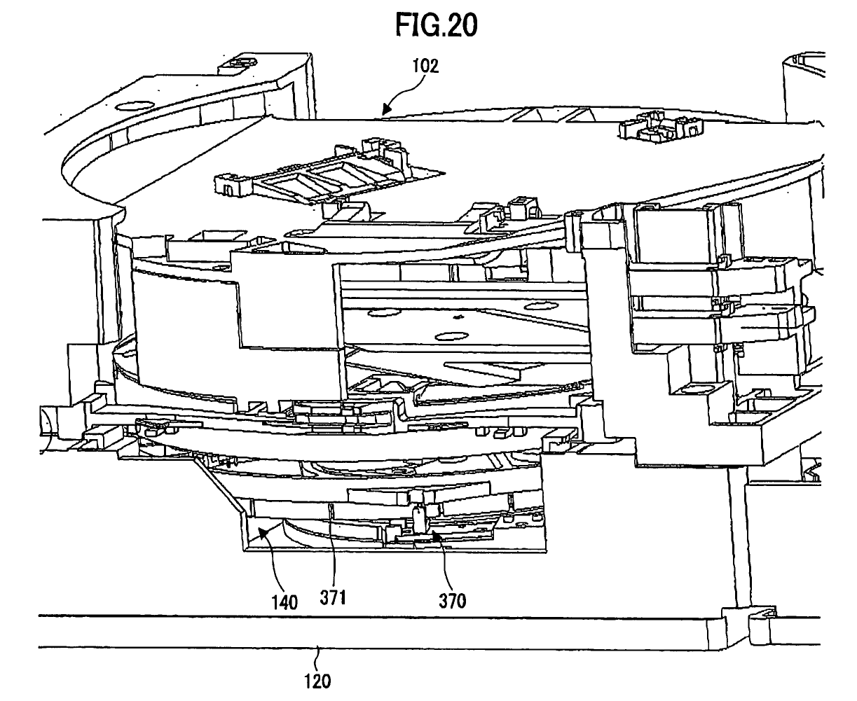

Referring to FIG. 20, the photo sensor 370 for detecting the rotating angle of the turntable 140 is provided. The photo sensor 370 detects the rotating angle of the turntable 140 by detecting slits 371, which can be formed in a predetermined arrangement on a rib around a lower face of the turntable 140. in one embodiment, the rotating angle of the turntable 140 and the moving distance of the drive shaft unit 301 can have the following relation; When the rotating angle of the turntable 140 is approximately 15 degrees, the moving distance of the drive shaft unit 301 is approximately 2.5 mm; when the rotating angle of the turntable 140 is approximately 30 degrees, the moving distance of the drive shaft unit 301 is approximately 5 mm; and when the rotating angle of the turntable 140 is approximately 90 degrees, the moving distance of the drive shaft unit 301 is approximately 15 mm. However, it is recognized that other suitable arrangements can be utilized with the present invention depending upon the design requirements of the autoloader.

4-3 [Configuration of Magazine Drive Motor Module 330]

As shown in FIG. 5, in the magazine drive motor module 330, the magazine drive motor 333 is secured to a flange section 332 of a frame 331. A reduction gear 334 is held in the flange section 332. The reduction gear 334 engages a gear 335 secured to a spindle of the magazine drive motor 333.

The magazine drive motor module 330 is secured to the Y1-side end of the base 120 such that the reduction gear 334 engages the gear 312 as shown in FIG. 15.

When the magazine drive motor 333 is driven, the gear 312 is rotated through the reduction gear 334. Accordingly, the drive shaft 310 and the drive gears 313X1 and 313X2 are rotated.

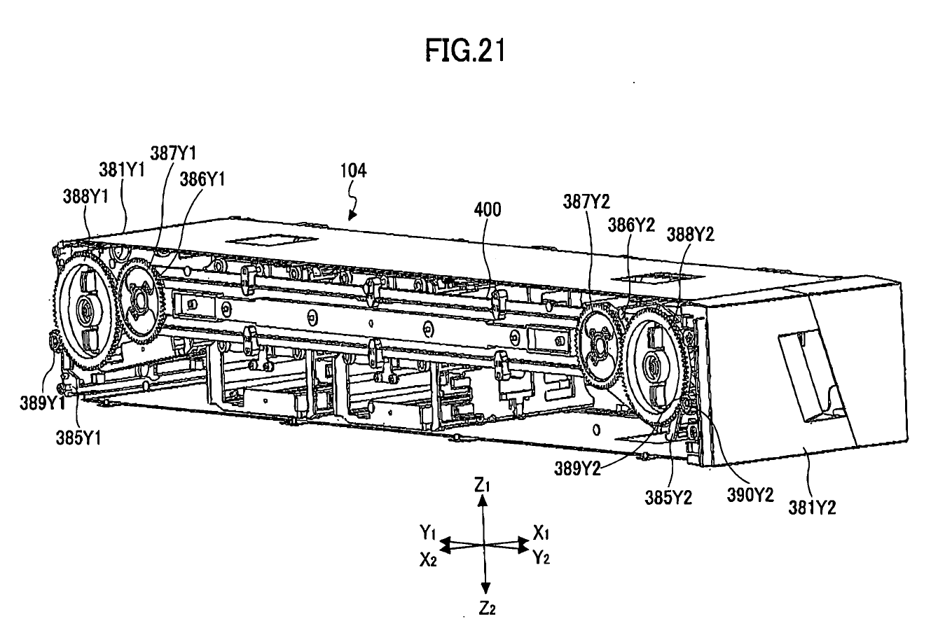

5 [Configuration of Tape Cartridge Transport Magazines 103, 104] (FIGS. 21-23)

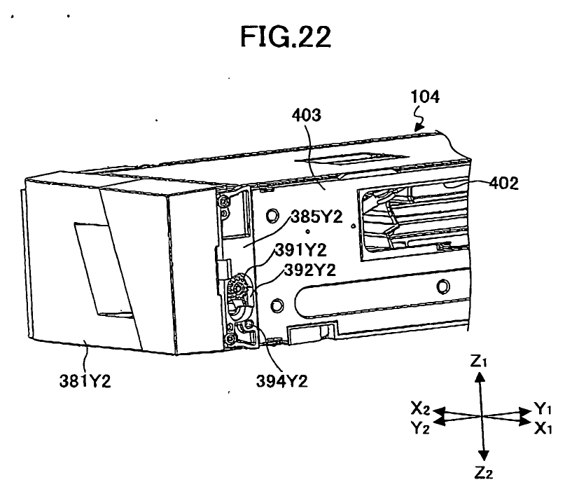

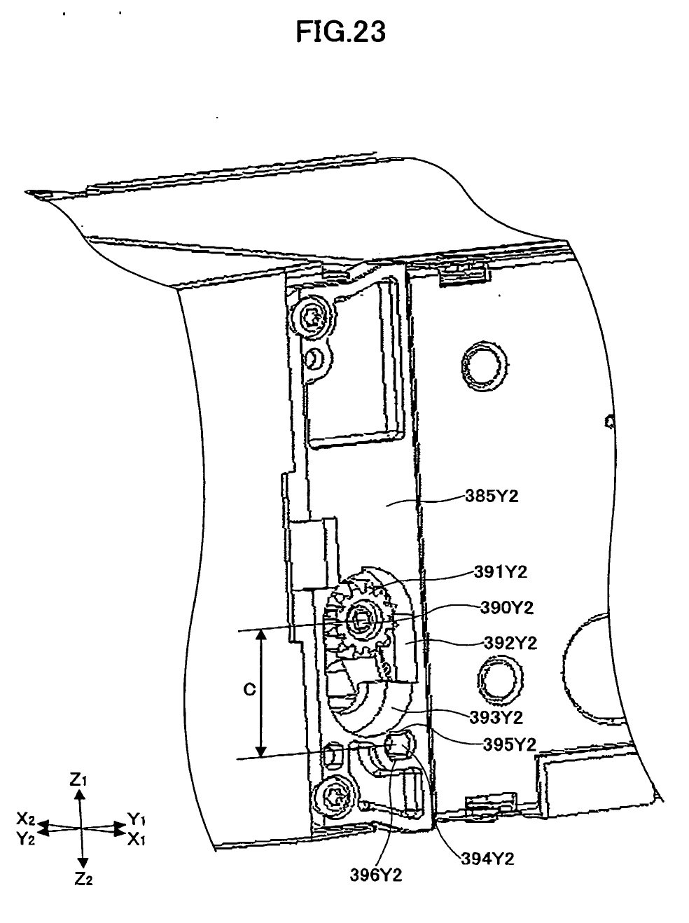

FIG. 21 is a perspective view of the tape cartridge transport magazine 104 with an X2-side lateral plate removed, viewed from the X2 side. FIG. 22 is a perspective view of the tape cartridge transport magazine 104 of FIG. 21, viewed from the X1 side. FIG. 23 is an enlarged view illustrating a part of the tape cartridge transport magazine 104 of FIG. 22.

Referring to FIG. 21, the tape cartridge transport magazine 104 is a quadrangular prism elongated in the Y1-Y2 direction and comprises decorative panels 381Y1 and 381Y2 at opposing ends in the longitudinal direction. In one embodiment, the tape cartridge transport magazine 104 can be installable at both the X1 side and the X2 side of the main module 110 by reversing the longitudinal orientation without turning it upside down. Alternatively, the tape cartridge transport magazine 104 can be positioned and/or oriented differently relative to the main module 110.

As shown in FIG. 21, a frame 385Y2, a pulley 386Y2, a large-diameter gear member 385Y2 that engages a gear section 387Y2 provided at the end of the pulley 386Y2, and a small-diameter gear member 389Y2 that engages the large-diameter gear member 388Y2 are provided at the Y2 side. The small-diameter gear member 389Y2 is secured to an end of a rotary shaft 390Y2.

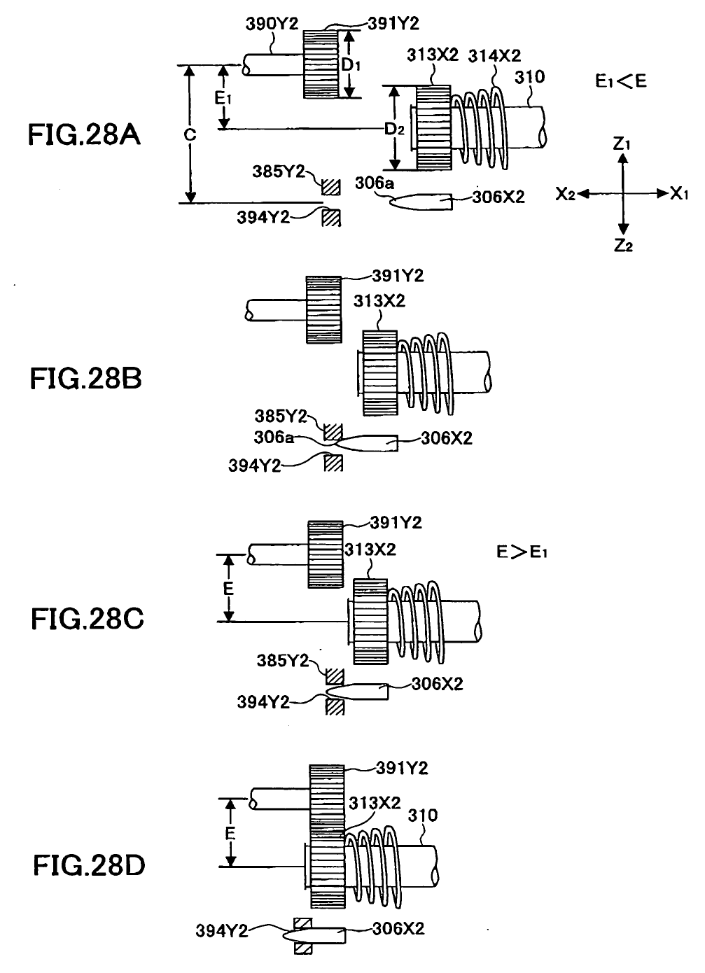

As shown in FIGS. 22 and 23, a small-diameter magazine gear 391Y2 is secured to the opposite end of the rotary shaft 390Y2. An opening 392Y2 elongated in the z direction is formed in the frame 385Y2. The magazine gear 391Y2 is exposed from a Z1-side part of the opening 392Y2. The opening 392Y2 includes an opening portion 393Y2 having a size that allows the drive gear 313X2 to be fitted therein. A positioning hole 394Y2 is formed at the Z2 side of the opening portion 393Y2 in the frame 385Y2. The positioning hole 394Y2 is elongated in the Y1-Y2 direction and includes linear edges 395Y2 and 396Y2 at the Z1 side and the Z2 side, each extending in the Y1-Y2 direction. The positioning hole 394Y2 is formed at the Z2 side of the magazine gear 391Y2 with a distance C therebetween (see FIG. 28A). The distance C is determined based on the distance A, a pitch circle diameter D1 of the magazine gear 391Y2, and a pitch circle diameter D2 of the drive gear 313X2 such that the center distance between the magazine gear 391Y2 and the drive gear 313X2 is set to an appropriate value E when the positioning pin 306X2 (FIG. 19) is fitted in the positioning hole 394Y2.

Referring back to FIG. 21, a frame 385Y1, a pulley 386Y1, a gear section 387Y1, a large-diameter gear member 388Y1, a small-diameter gear member 389Y1, and a magazine gear are provided at the Y1 side similar to the Y2 side.

Plural tape cartridge containers (also referred to as “carriers”) 401 are disposed at even intervals on a timing belt 400 (also sometimes referred to herein as a container positioner) extending around the pulleys 386Y1 and 386Y2 (see FIGS. 2 and 21).

An opening 402 (FIG. 22) having a size corresponding to the tape cartridge 10 is formed in an X2-side lateral plate 403 of the magazine 104 so as to oppose the tape cartridge picker 102 when the magazine 104 is mounted. Also, openings (not shown) for inserting tape cartridges 10 are formed in the lateral plate 403 of the magazine 104 so as to oppose the corresponding tape cartridge containers 401 (FIG. 2).

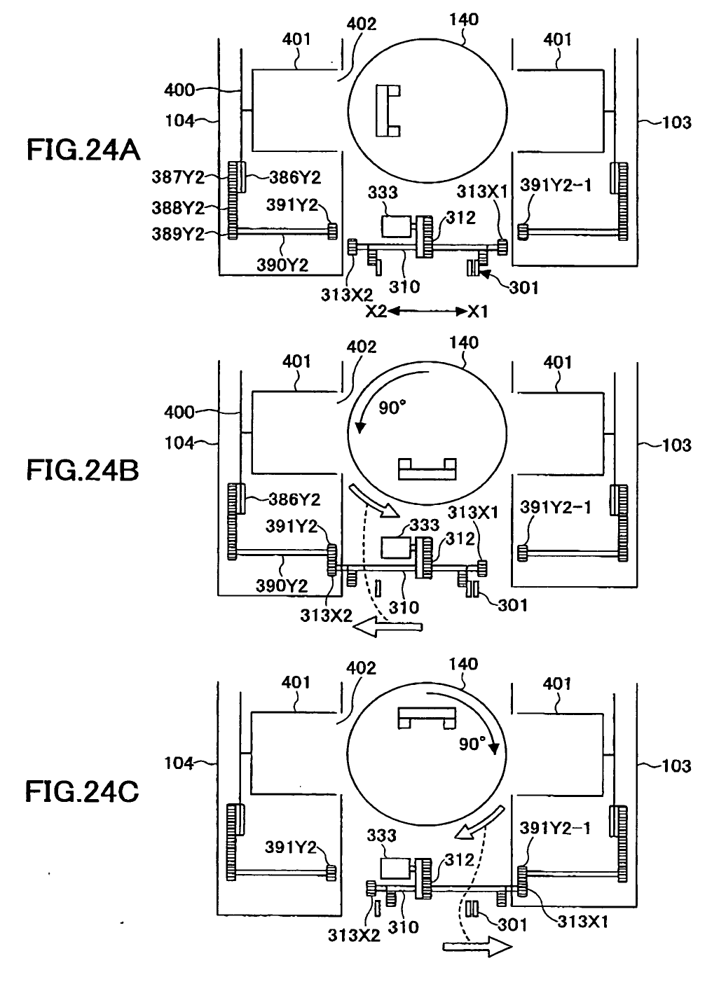

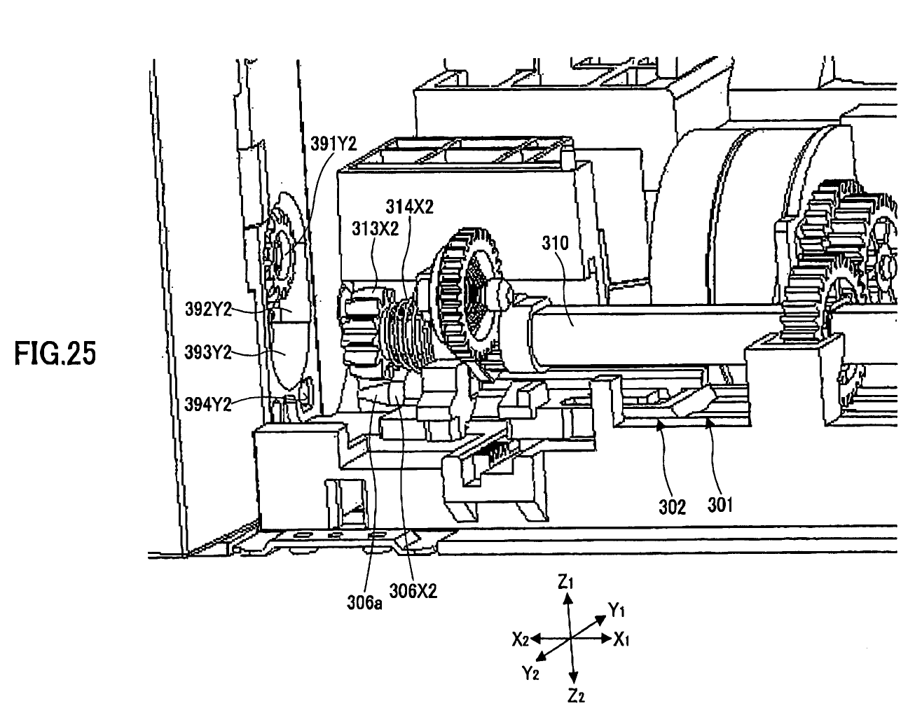

When the tape cartridge transport magazines 103 and 104 are attached at the X1 side and the X2 side as shown in FIG. 1, the drive shaft unit 301 can be located at the home position shown in FIG. 24A. At the X2 side, as shown in FIG. 25, the magazine gear 391Y2, the opening 392Y2, and the positioning hole 394Y2 oppose the drive gear 313X2 (313X1) and the positioning pin 306X2 (306X1). The opening 402 opposes the tape cartridge picker 102.

6 [Operations for Selectively Driving Tape Cartridge Transport Magazines 103, 104] (FIGS. 24A-29D)

FIG. 24B shows a state to drive the tape cartridge transport magazine 104. FIG. 24C shows a state to drive the tape cartridge transport magazine 103.

When a command to drive the tape cartridge transport magazine 104 is input, the stepping motor 165 is driven in the normal direction by the motor control circuit 410 so as to drive the magazine drive motor 333 (see FIG. 4).

When the stepping motor 165 is driven, the turntable 140 is rotated in the counterclockwise direction through the reduction gear train 166 (FIG. 9). At the same time, the drive shaft unit 301 is driven in the X2 direction through the gear member 321 (FIG. 13) and the rack 305. The stepping motor 165 is stopped at the time when the photo sensor 370 (FIG. 20) detects that the turntable 140 is rotated by a predetermined amount, such as by approximately 90 degrees in the counterclockwise direction. The drive shaft unit 301 is moved in the X2 direction, so the drive gear 313X2 is inserted into the opening portion 393Y2 to mesh with the magazine gear 391Y2. Thus, the magazine drive 300 establishes a rotation transmission path from the magazine drive motor 333 to the tape cartridge transport magazine 104.

The stepping motor 165 for rotating the turntable 140 is also used for moving the drive shaft unit 301. Therefore, there is no need to provide a stepping motor exclusively used for moving the drive shaft unit 301. It is so designed that the tape cartridge picker 102 is at rest while the tape cartridge transport magazine 104 is driven. According to an embodiment of the present invention, a part of the resting tape cartridge picker 102 is operated for moving the drive shaft unit 301.

As the drive shaft unit 301 is interlocked with the turntable 140, the moving distance of the drive shaft unit 301 is found by detecting the rotating angle of the turntable 140. Therefore, there is no need to provide the drive shaft unit 301 with a mechanism for detecting the moving distance.

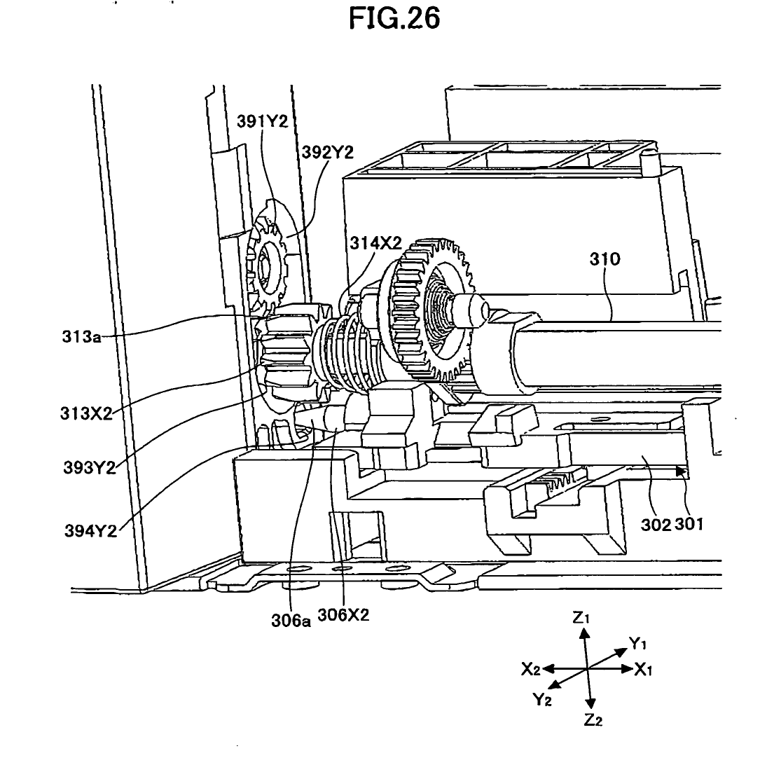

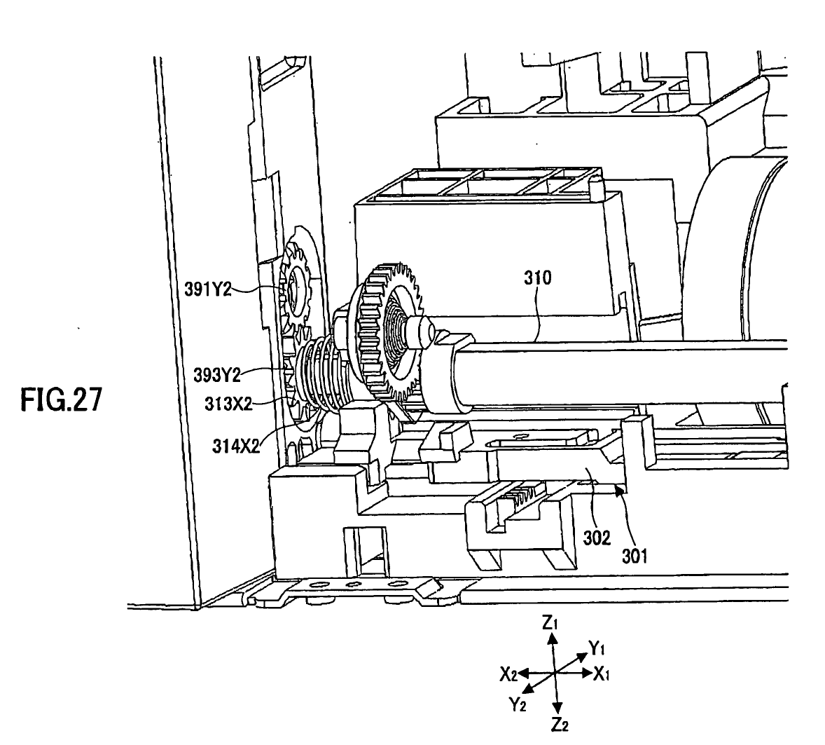

At the final stage of the movement of the drive shaft unit 301 in the X2 direction, the following operations illustrated in FIGS. 26 and 27 are performed.

Just before the drive gear 313X2 contacts the magazine gear 391Y2, the positioning pin 306X2 fits into the positioning hole 394Y2 (see FIGS. 26, 28B, and 28C) so as to set the center distance between the magazine gear 391Y2 and the drive gear 313X2 to the appropriate value E (FIG. 28C). When the drive shaft unit 301 is further moved in the X2 direction to be inserted into the opening portion 393Y2 from the lateral side thereof, tooth sections of the drive gear 313X2 fit into tooth groove sections of the magazine gear 391Y2 (see FIGS. 27, 24B, and 28B). Thus, the drive gear 313X2 correctly engages the magazine gear 391Y2. The taper face 313b helps the drive gear 313X2 to smoothly mesh with the magazine gear 391Y2.

FIGS. 28A-28D illustrate operations for correcting the center distance between the drive gear 313X2 and the magazine gear 391Y2 to the appropriate value E just before the drive gear 313X2 engages the magazine gear 391Y2.

FIG. 28A illustrates the magazine gear 391Y2 and the drive gear 313X2 located at the positions shown in FIGS. 24A and 25. Supposing that the center distance between the magazine gear 391Y2 and the drive gear 313X2 is a value E1 smaller than the appropriate value E. This situation may occur when, for example, the frame 500 is distorted at the time of mounting the tape cartridge autoloader 100 on the rack or when there is an assembly error in the tape cartridge autoloader 100.

When the drive shaft unit 301 is moved in the X2 direction, a tip end of the conical section 306a of the positioning pin 306X2 is inserted into the positioning hole 394Y2 as shown in FIG. 28B and further inserted as shown in FIG. 28C before the drive gear 313X2 reaches the magazine gear 391Y2. During this process, the drive gear 313X2 is slightly moved in the Z2 direction or the tape cartridge transport magazine 104 is slightly moved in the Z1 direction, so that the center distance between the magazine gear 391Y2 and the drive gear 313X2 is corrected to the appropriate value E After the center distance is corrected to the appropriate value E, the drive gear 313X2 correctly engages the magazine gear 391Y2.

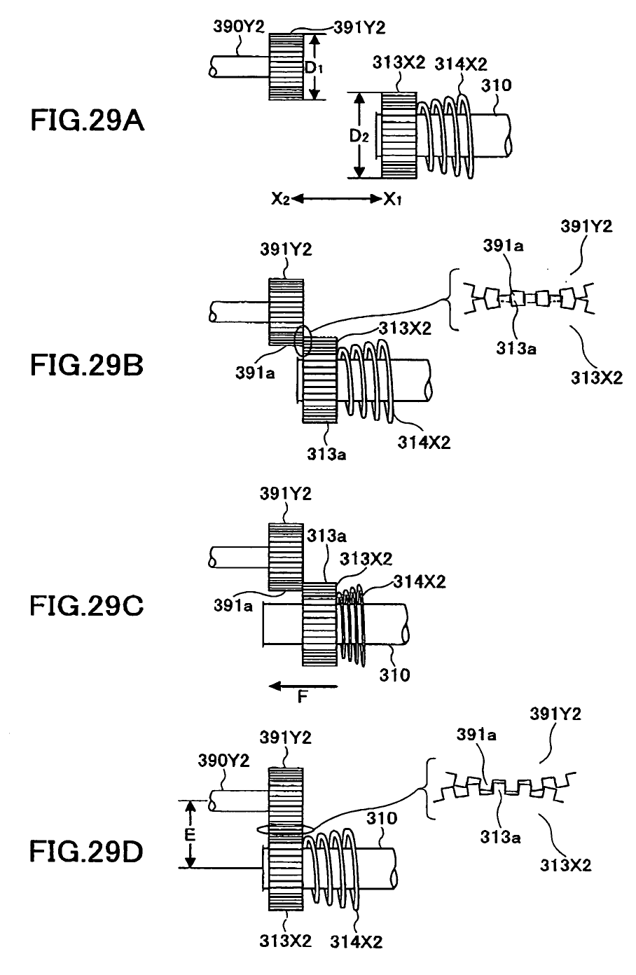

FIGS. 29A-29D illustrate operations for locating the drive gear 313X2 to correctly mesh with the magazine gear 391Y2 when the tooth sections of the drive gear 313X2 contact and interfere with tooth sections of the magazine gear 391Y2.

FIG. 29B illustrates the tooth sections of the drive gear 313X2, which are moved in the X2 direction from the original position shown in FIG. 29A, contacting and interfering with the tooth sections of the magazine gear 391Y2.

When the drive shaft unit 301 is further moved in the X2 direction, the compression coil spring 314X2 is compressed as shown in FIG. 29C. Thus, the drive shaft unit 301 is moved to the final position. The drive gear 313X2 is stopped with lateral end faces of the tooth sections 313a abutting opposing lateral end faces of the tooth section 391a of the magazine gear 391Y2.

Then, the magazine drive motor 333 is started as described below, and accordingly the drive gear 313X2 is rotated. When the tooth sections of the rotating drive gear 313X2 oppose the tooth groove sections of the magazine gear 391Y2, the drive gear 313X2 is moved in the X2 direction with a spring force F of the compression coil spring 314X2 so as to correctly mesh with the magazine gear 391Y2 as shown in FIG. 29D.

After the drive gear 313X2 engages the magazine gear 391Y2, the gear 312 is rotated by the magazine drive motor 333 through the reduction gear 334. Accordingly, the drive shaft 310, the drive gears 313X1 and 313X2 are rotated. The rotation of the drive gear 313X2 is transmitted to the magazine gear 391Y2, the large-diameter gear member 388Y2, the gear section 387Y2, and to the pulley 386Y2 (FIG. 24A). Thus, the timing belt 400 is driven so as to move and/or position the tape cartridge containers 401 together with the tape cartridges 10 stored in the tape cartridge containers 401.

When a command to stop driving the tape cartridge transport magazine 104 is input, the magazine drive motor 333 is stopped. Then, the stepping motor 165 is driven in the reverse direction to rotate the turntable 140 back to the home position. Also, the drive shaft unit 301, through the gear member 321 and the rack 305, is moved in the X1 direction back to the home position shown in FIG. 24A.

If a command to drive the tape cartridge transport magazine 103 is input when the drive shaft unit 301 is located at the home position shown in FIG. 24A, the stepping motor 165 is driven in the reverse direction by the motor control circuit 410 (FIG. 4) so as to drive the magazine drive motor 333. Thus, the drive gear 313X1 correctly engages a magazine gear 391Y2-1 of the tape cartridge transport magazine 103 (see FIG. 24C) in the same manner as described above. Accordingly, the belt 400 is driven by the magazine drive motor 333 so as to move the tape cartridge containers 401.

When a command to stop driving the tape cartridge transport magazine 103 is input, the magazine drive motor 333 is stopped. Then, the stepping motor 165 is driven in the reverse direction to rotate the turntable 140 back to the home position. Also, the drive shaft unit 301, through the gear member 321 and the rack 305, is moved in the X2 direction back to the home position shown in FIG. 24A.

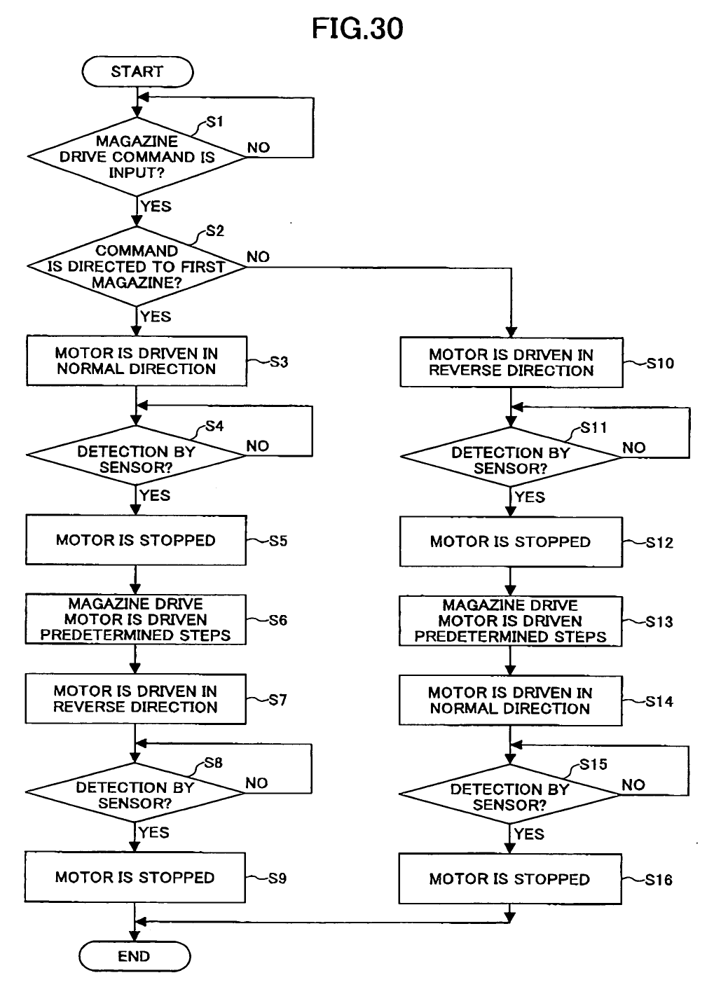

7 [Operations of Microcomputer of Motor Control Circuit 410] (FIG. 30)

The microcomputer of the motor control circuit 410 operates as illustrated in FIG. 30.

When a magazine drive command is input, the microcomputer determines whether the command is directed to the first media transport magazine 104 (S1, S2). If the command is directed to the first media transport magazine 104, the microcomputer drives the stepping motor 165 in the normal direction. When the photo sensor 370 detects that the turntable 140 is rotated approximately 90 degrees, for example, in the counterclockwise direction, the microcomputer stops the stepping motor 165 (S3, S4, S5). After that, the magazine drive motor 333 is driven predetermined steps (S6). The microcomputer then drives the stepping motor 165 in the reverse direction. When the photo sensor 370 detects that the turntable 140 is rotated in the clockwise direction to the home position, the microcomputer stops the stepping motor 165 (S7, S8, S9)

If the command is directed to the second media transport magazine 103, the microcomputer drives the stepping motor 165 in the reverse direction. When the photo sensor 370 detects that the turntable 140 is rotated 90 degrees in the clockwise direction, the microcomputer stops the stepping motor 165 (S10, S11, S12). After that, the magazine drive motor 333 is driven predetermined steps (S13). The microcomputer then drives the stepping motor 165 in the normal direction. When the photo sensor 370 detects that the turntable 140 is rotated in the counterclockwise direction to the home position, the microcomputer stops the stepping motor 165 (S14, S15, S16).

8 [Transport Mechanism of Tape Cartridge Container 401]

The tape cartridge transport magazines 103, 104 are configured to transport one or more tape cartridge containers 401 (See FIG. 2) having the tape cartridges 10 stored therein. Inside the tape cartridge transport magazines 103, 104, multiple tape cartridge containers 401 (for example, eight containers) are connected to the timing belt 400. Therefore, the tape cartridge transport magazines 103, 104 are able to store a number of tape cartridges 10 that correspond with the same or greater number of tape cartridge containers 401 provided therein.

Next, a configuration of the tape cartridge container 401 is described which is followed by a description of a configuration of the container transport mechanism.

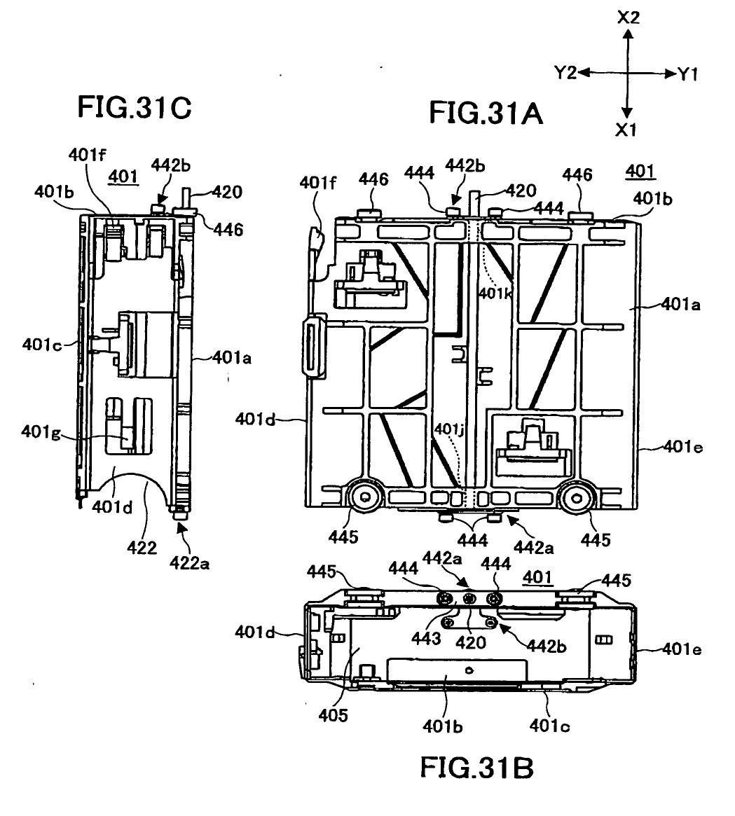

FIGS. 31A through 31C are drawings showing the tape cartridge container 401, in which FIG. 31A is a plane view of the tape cartridge container 401, FIG. 31B is a front view of the tape cartridge container 401, and FIG. 31C is a side view of the tape cartridge container 401. As shown in FIGS. 31A through 31C, the tape cartridge container 401 includes a top plate 401a, a rear plate 401b, a bottom plate 401c, and side plates 401d, 401e, to thereby form a cartridge storage space 405 that is surrounded by walls except in the direction at which the opening 422 is provided. Furthermore, in this embodiment, a first latching section (latching part) 401f is provided to the side plate 401d (towards the rear plate 401b) for latching an A-type tape cartridge 10. Furthermore, a second latching section 401g is also provided to the side plate 401d for latching a B-type tape cartridge 10 having shape and/or size that is different from that of the A-type tape cartridge 10. It is to be noted that the first latching section 401f and the second latching section 401g are disposed at positions corresponding to the different types of tape cartridges 10 (e.g. different in size), respectively, so that either one of the latching sections 401f, 401g may serve as a cartridge latching part. It is also to be noted that the positioning and configuration of the first latching section 401f and the second latching section 401g can vary depending upon the design requirements of the tape cartridge transport magazine 103, 104, and the tape cartridge autoloader 100. A case where the A-type tape cartridge 10 is stored in the tape cartridge container 401 is described below.

Through-holes 401j and 401k, which penetrate the tape cartridge container 401 in the X1-X2 direction, are provided in or near the center of the ceiling plate 401a. A shaft 420, which is made of metal or another similarly rigid material, is inserted in the through-holes 401j and 401k. The ends of the shaft 420 protrude from the corresponding front and rear ends of the ceiling plate 401a. A belt coupling member (not shown, to be described below) and roller members 442a, 442b are attached to both ends of the shaft 420. Furthermore, one or more rollers 445 (two rollers 445 are shown in FIG. 31A) are rotatably attached toward the opening 422 side of the ceiling plate 401a for rotating with respect to the lateral plate 403. Furthermore, one or more rollers 446 (two rollers 446 are shown in FIG. 31A) are provided on the rear plate 401b for rotating with respect to a lateral plate (not shown) that supports the belt 400.

The rollers 445, which can be disposed on the front side of the tape cartridge container 401, rotate when the tape cartridge container 401 moves horizontally (horizontal movement). The rollers 446, which can be disposed on the rear side of the tape cartridge container 401, rotate when the tape cartridge container 401 moves vertically (vertical movement (lifting movement)).

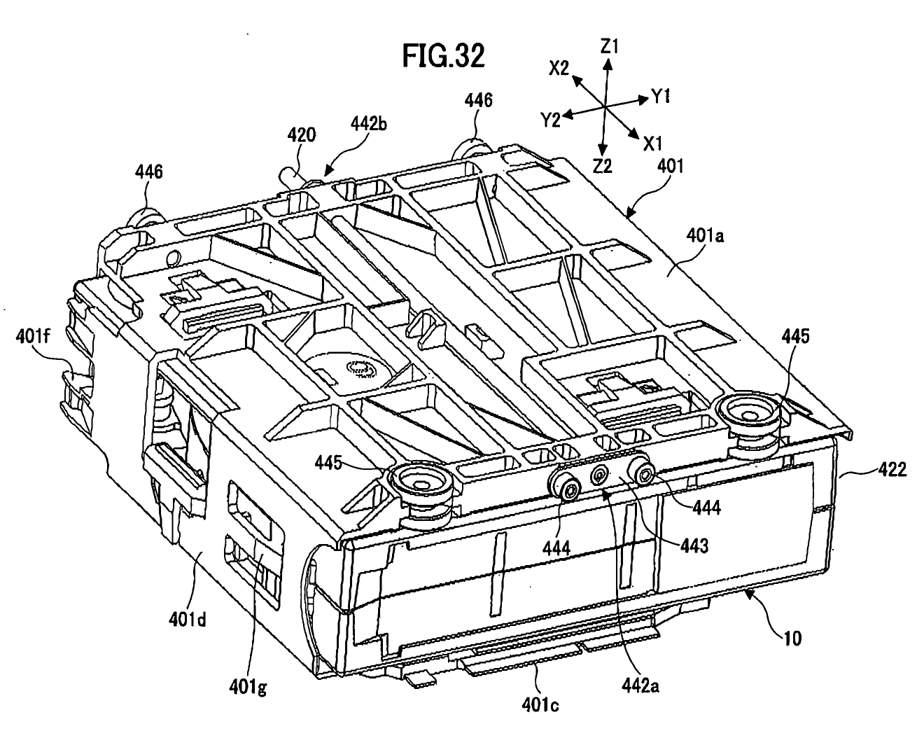

FIG. 32 is a perspective view of the tape cartridge container 401. As shown in FIG. 32, the tape cartridge 410 is inserted into the cartridge storage space 405 of the tape cartridge container 401 from the opening 422 and can be latched at a predetermined storage position by the latching sections 401f, 401g. In this state where the tape cartridge 410 is stored in the tape cartridge container 401, the tape cartridge 410 is not protruding to any significant degree or at all from the opening 422.

A driving force in a transporting direction is transmitted to one end of the shaft 420 which is supported by a container transport mechanism 430 (not shown, to be described below). The other end of the shaft 420, which is supported by a container guide mechanism 440 (not shown, to be described below), is guided in the transporting direction. Accordingly, the tape cartridge container 401 is transported in a state in which the tape cartridge container 401 can be suspended in an oscillatable manner with the shaft 420 serving as its axis. In addition, by rolling the four rollers 445, 446 along the lateral plates of the tape cartridge transport magazine 103, 104, the tape cartridge container 401 can be stably transported without the shaft 420 being tilted.

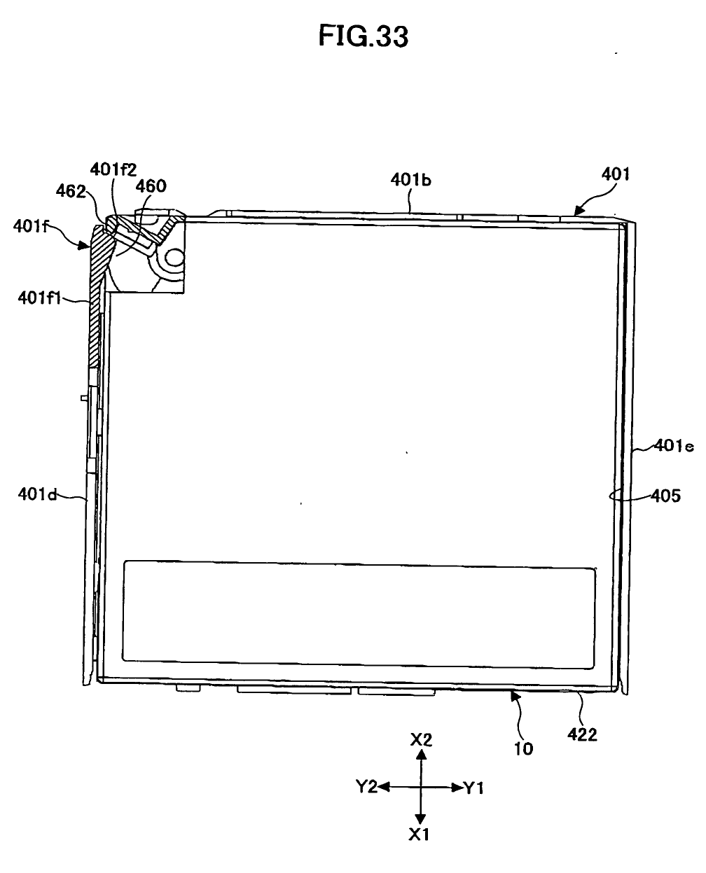

FIG. 33 is a partly cutaway plan view of the tape cartridge container 401 having the tape cartridge 10 stored in the cartridge storage space 405. As shown in FIG. 33, when the tape cartridge 10 is inserted into a predetermined storage position in the cartridge storage space 405, the latching section 401f provided on the rear plate 401b side of the side plate 401d of the tape cartridge container 401 engages a concave latching section 460 of the tape cartridge 10. The latching section 401f comprises an arm part 401f₁ which extends in the X2 direction and an engaging part 401f₂ which is situated on the tip end of the arm part 401f₁ and is formed with a curved face (arcuate face).

Accordingly, the tape cartridge 10 inserted into a predetermined storage position in the cartridge storage space 405 is latched in a state in which the engaging part 401f₂ of the latching section 401f abuts an edge part 462 of the concave latching section 460. It is to be noted that, since the latching section (latching part) 460 latches with the tape cartridge 10 in a manner having the engaging part 401f₂ with the curved face abut against the edge part 462 of the concave latching section 460 at a given point(s) (point contact), in one embodiment, the edge part 462 of the concave latching section 460 presses against the engaging part 401f₂ of the latching section 401f and causes the latching section (latching part) 460 to elastically deform in the Y2 direction (direction separating from the concave latching section 460) when the tape cartridge 10 is drawn out (pulled out) in the X1 direction. Thereby, the latching state of the tape cartridge 10 can be released.

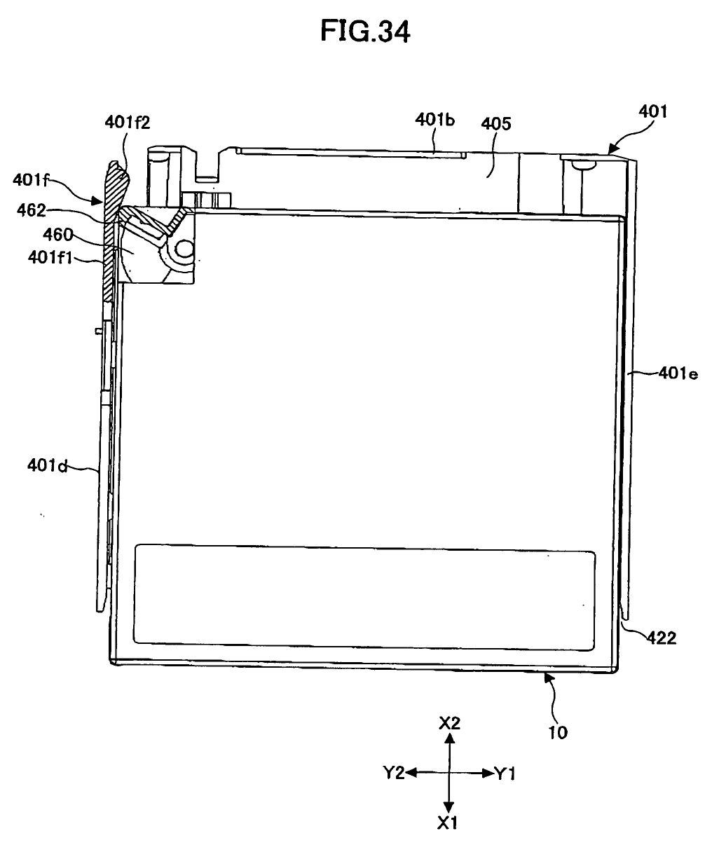

FIG. 34 is a partly cutaway plan view of the tape cartridge container 401 having the tape cartridge 10 released from the cartridge storage space 405. As shown in FIG. 34, since the latching of the latching section 401f is released when the tape cartridge 10 is pulled out in the X1 direction, the retrieving operation of the tape cartridge picker 102 can be performed with relatively little resistance, to thereby achieve smooth retrieval of the tape cartridge 10.

In a case where vibration or shock is applied to the tape cartridge container 401, the latched state of the tape cartridge 10 may be released in a manner similar to the operation of retrieving the tape cartridge 10.

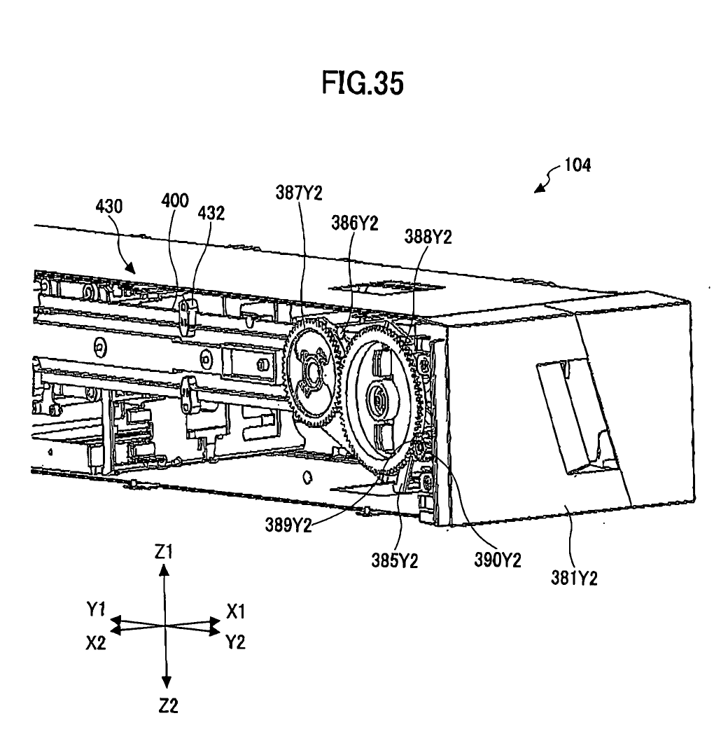

FIG. 35 is a perspective view showing a container transport mechanism 430. It is to be noted that FIG. 35 shows only the Y2 side of the tape cartridge magazine 104 (Y1 side omitted). As shown in FIG. 35, the container transport mechanism 430 includes: the above-described pulleys 386Y1, 386Y2; the gear sections 387Y1, 387Y2; the large-diameter gear members 388Y1, 388Y2; the small-diameter gear members 389Y1, 389Y2; the timing belt 400; and a belt coupling member(s) 432 coupled to the timing belt 400.

In this embodiment, the belt coupling member 432 is fixedly engaging to one end of the shaft 420. The one end of the shaft 420 is chamfered into a non-circular shape (D letter shape) and its rotating movement is regulated with respect to the belt coupling member 432.

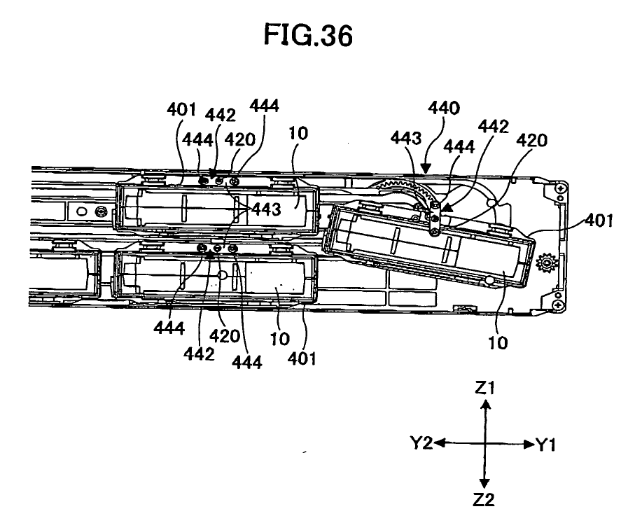

FIG. 36 is a perspective view of one embodiment of a container guide mechanism 440. As shown in FIG. 36, the container guide mechanism 440 can include a roller member 442 rotatably engaged with the other end of the shaft 420, and a guide groove (not shown) for guiding the transportation of the roller member 442. The roller member 442 includes a metal plate 443 extending in a direction perpendicularly intersecting with the shaft 420, and one or more rollers 444 (a pair of rollers 444 are shown for each container guide mechanism 440 in FIG. 36) supported in the vicinity of both ends of the metal plate 443.

The pair of rollers 444 rotate along the guide groove (not shown) for guiding the transportation of the tape cartridge container 401. It is to be noted that in one embodiment, the guide groove is formed in a somewhat oval or racetrack-shaped loop along a path through which the tape cartridge container 401 is transported (transportation path). However, the guide groove can be arranged in a different shape that can be varied depending upon the design requirements of the autoloader 100 and the tape cartridge transport magazines 103 and 104. Since the roller member 442 oscillates with respect to the shaft 420 when the pair of rollers 444 passes through a curved part (arcuate part) of the guide groove, the tape cartridge container 401 can be transported in a slightly tilted state.

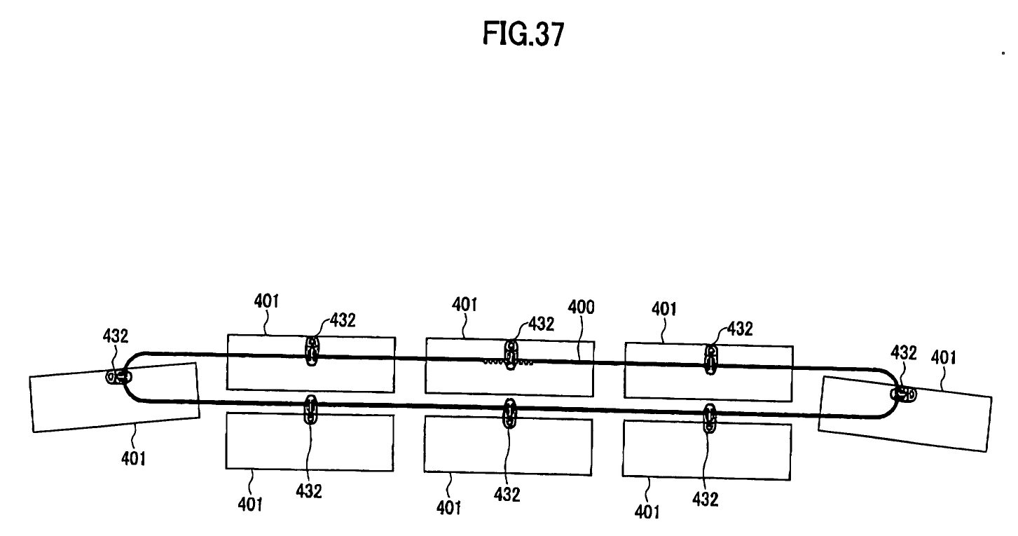

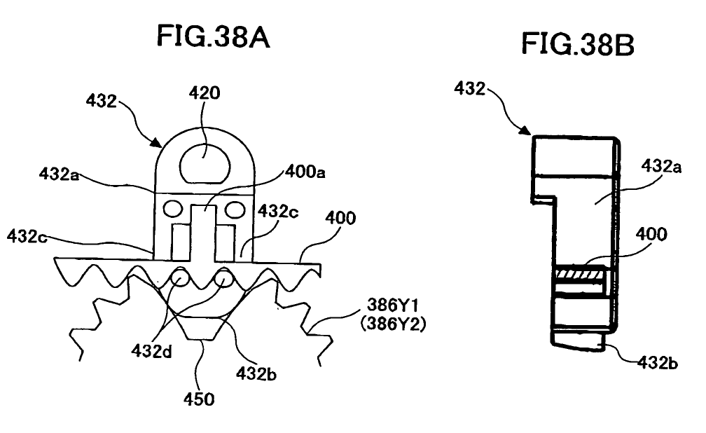

Next, a configuration and an attachment structure of the belt coupling member 432 are described. FIG. 37 shows a state where the tape cartridge containers 401 are coupled to the timing belt 400 via corresponding belt coupling members 432. FIGS. 38A and 38B are enlarged views for showing the attachment structure of the belt coupling member 432, in which FIG. 38A is a front view of the belt coupling member 432, and FIG. 38B is a side view of the belt coupling member 432.

In this example (See FIG. 37), eight tape cartridge containers 401 are coupled to the somewhat oval-loop timing belt 400 at predetermined intervals, in which the tape cartridge containers 401 are coupled to the timing belt 400 via the belt coupling members 432. It is recognized that although the embodiment in FIG. 37 includes eight tape cartridge containers 401, any suitable number of containers 401 can be included in each of the one or more tape cartridge transport magazines 103, 104.

Since each belt coupling member 432 travels horizontally while maintaining a vertical state when passing through a horizontally extending portion of the somewhat oval-loop timing belt 400, the load (weight) of each tape cartridge container 401 is applied in a direction perpendicularly intersecting with the timing belt 400 (direction of a force pressing the timing belt 400 against the pulleys 386Y1, 386Y2). Thereby, the timing belt 400 can maintain a stable traveling state.

Furthermore, since each belt coupling member 432 travels downward or upward while rotating along the outer periphery of the pulleys 386Y1, 386Y2 when passing through a return portion (curved portion on both ends of the timing belt 400) of the oval-loop timing belt 400, the direction of the load applied to the belt coupling member 432 changes correspondingly. Particularly, when the belt coupling member 432 is rotated to a horizontal state, the traveling direction and the load direction match such that acceleration is applied to the belt coupling member 432. In this situation, since a moment forcing the timing belt 400 to separate from the pulleys 386Y1, 386Y2 is applied to the belt coupling member 432, the traveling state of the timing belt 400 may become unstable.

In one embodiment, the belt coupling member 432 can be molded from any suitable material, such as a resin material, metal, plastic, etc., and can also be integrally molded with the timing belt 400 by employing an outsert molding method (See FIGS. 38A and 38B). Alternatively the belt coupling member 432 can be separately formed from the timing belt 400. In this embodiment, the belt coupling member 432 includes: an outer projecting section 432a which is engaged with a protrusion 400a in a manner projecting in an outward direction with respect to the timing belt 400, an inner projecting section 432b

which is provided in a manner projecting in an inward direction with respect to the timing belt 400, an outer abutting section 432c which abuts the outer side of the timing belt 400, and an inner abutting section 432d which abuts the inner side of the timing belt 400 between the teeth of timing belt 400.

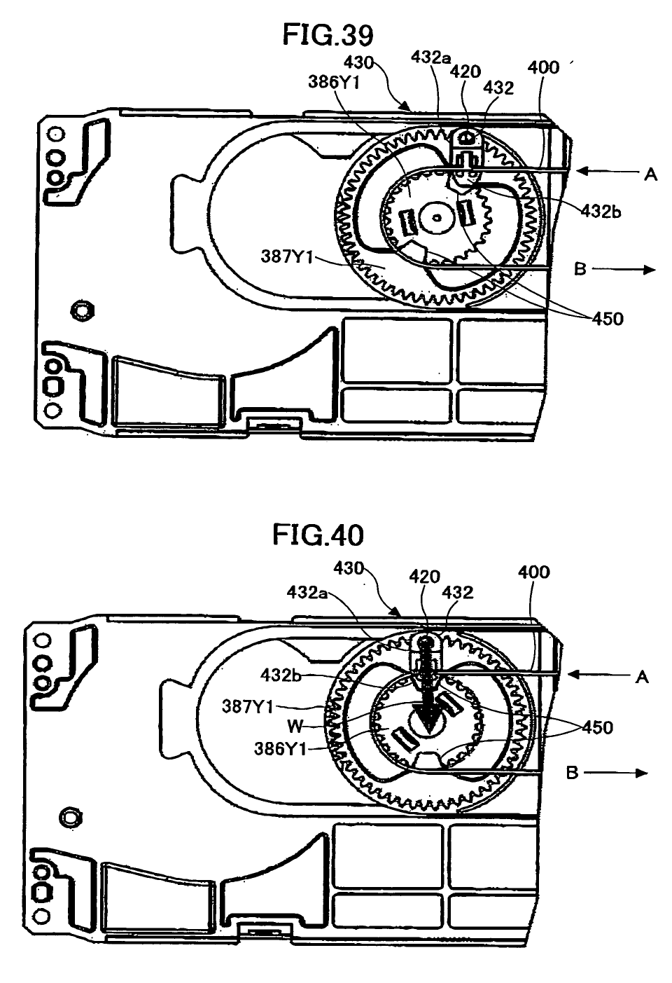

In one embodiment, one or more concave engaging sections 450 are disposed at predetermined intervals, such as at approximately 180 degree intervals in the pulleys 386Y1, 386Y2 for driving the timing belt 400. The concave engaging sections 450 can have a somewhat trapezoidal shape as shown in FIGS. 39 and 40, although other suitable shapes can be used. In this embodiment, the concave engaging section 450 smoothly engages the inner abutting section 432d when rotated and has an outer portion formed in a widening curved manner for smoothly disengaging with the inner abutting section 432d.

Further, in this embodiment, the inner projecting section 432b can be formed with an inverted trapezoidal shape for engaging with the concave engaging section 450 of the rotating pulleys 386Y1, 386Y2. Accordingly, the tape cartridge 10 and the tape cartridge container 401 are mechanically held such that their load (weight) W can be supported.

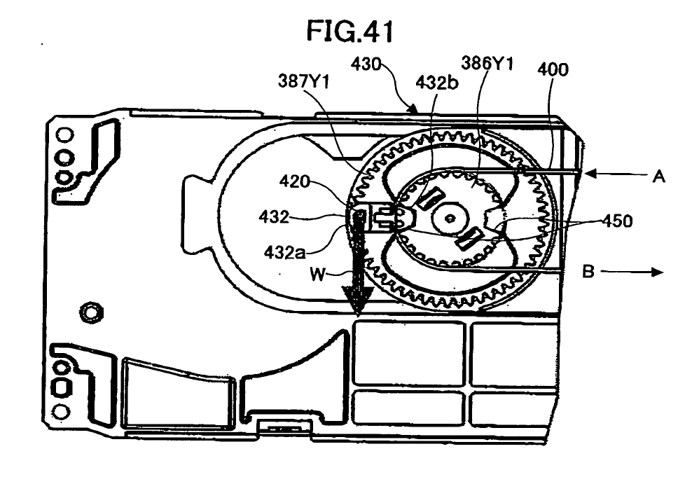

Next, the engagement of the pulley 386Y1 and the belt coupling member 432 is described. FIG. 39 shows a state prior to the engagement of the pulley 386Y1 and the belt coupling member 432. FIG. 40 shows a state where the pulley 386Y1 and the belt coupling member 432 are engaged. FIG. 41 shows a state where the engaged state of the pulley 386Y1 and the belt coupling member 432 is rotated approximately 90 degrees.

As shown in FIG. 39, since the timing belt 400 engages the gear sections formed in the outer periphery of the pulley 386Y1, the pulley 386Y1 is driven to rotate in a counter-clockwise direction and the extended portion of the timing belt 400 above the pulley 386Y1 moves in the A-direction. Furthermore, since the timing belt 400 is positioned around in a somewhat oval loop manner as shown in FIG. 37, the extended portion of the timing belt 400 below the pulley 386Y1 moves in the B-direction.

Since the belt coupling member 432 moves in the traveling direction of the timing belt 400, the belt coupling member 432 is drawn toward the outer periphery of the pulley 386Y1 and relatively engages the pulley 386Y1 by having the inner projecting section 432b admitted into the concave engaging section 450.

As shown in FIG. 40, when the belt coupling member 432 is situated on the rotation axis of the pulley 386Y1, the inner projecting section 432b becomes sufficiently engaged with the concave engaging section 450. At the time of this engaged state, the load W of the tape cartridge 10 and the tape cartridge container 401 is applied in a downward direction that perpendicularly intersects with the traveling direction of the timing belt 400. Therefore, little or no moment is applied with respect to the belt coupling member 432. Accordingly, tape cartridge container 401 which is supported via the belt coupling member 432 can be stably suspended.

As shown in FIG. 41, when the pulley 386Y1 is rotated approximately 90 degrees in a counterclockwise direction, the belt coupling member 432 is rotated from a vertical state to a horizontal state, and the load W of the tape cartridge 10 and the tape cartridge container 401 is applied (via the shaft 420) in a downward direction that perpendicularly intersects with the belt coupling member 432. Accordingly, a moment forcing the timing belt 400 to separate from the outer periphery of the pulley 386Y1 is applied to the belt coupling member 432.

However, since the inner projecting section 432b is engaged with the concave engaging section 450, the belt coupling member 432 is able to maintain its horizontal state by having the concave engaging section 450 receive the moment. Accordingly, the tape cartridge container 401 can be lowered to the lower side of the pulley 386Y1 in a stable manner.

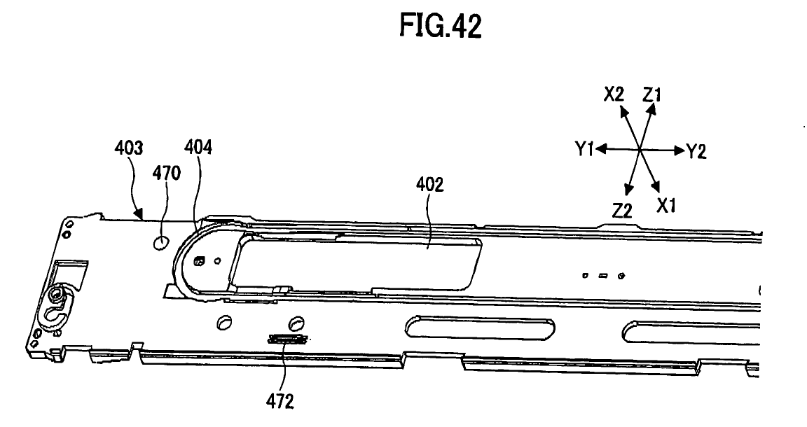

FIG. 42 is a perspective view showing a partial configuration of the lateral plate 403. As shown in FIG. 42, the lateral plate 403 is provided with the opening 402 from which the tape cartridge 10 is retrieved and a guide groove 404 on which the roller members 442 travel. Furthermore, the lateral plate 403 is also provided with a somewhat hemispherical-shaped first protrusion 470 situated at an incoming part of the curved portion of the guide groove 404 (positioned immediately before the tape cartridge container 401 begins being lowered (start position of lowering movement)) and a somewhat trapezoidal-shaped second protrusion 472, having inclined planes on both sides, situated at an outgoing part of the curved portion of the guide groove 404 (position immediately before the tape cartridge container 401 begins being raised (start position of raising movement)). It is recognized that the shapes of the protrusions 470, 472 can vary from those described and illustrated, however. The first protrusion 470 serves as a cartridge recovery part when the pulley 386Y1 is driven to rotate in a counterclockwise direction for transporting the tape cartridge container 401. The second protrusion 472 serves as another cartridge recovery part when the pulley 386Y1 is driven to rotate in a clockwise direction for transporting the tape cartridge container 401. It is understood that the terms “first protrusion” and “second protrusion” can be used interchangeably so that either of the protrusions can be the first protrusion 470 or the second protrusion 472

When the tape cartridge 10 is in a state protruding from the opening 422 during the lifting movement (vertical movement) along the outer periphery of the pulley 386Y1 of the tape cartridge container 401, it is possible that the tape cartridge 10 may contact the guide groove 404 of the lateral plate 403 (or another structure of the tape cartridge transport lifting movement (vertical movement).

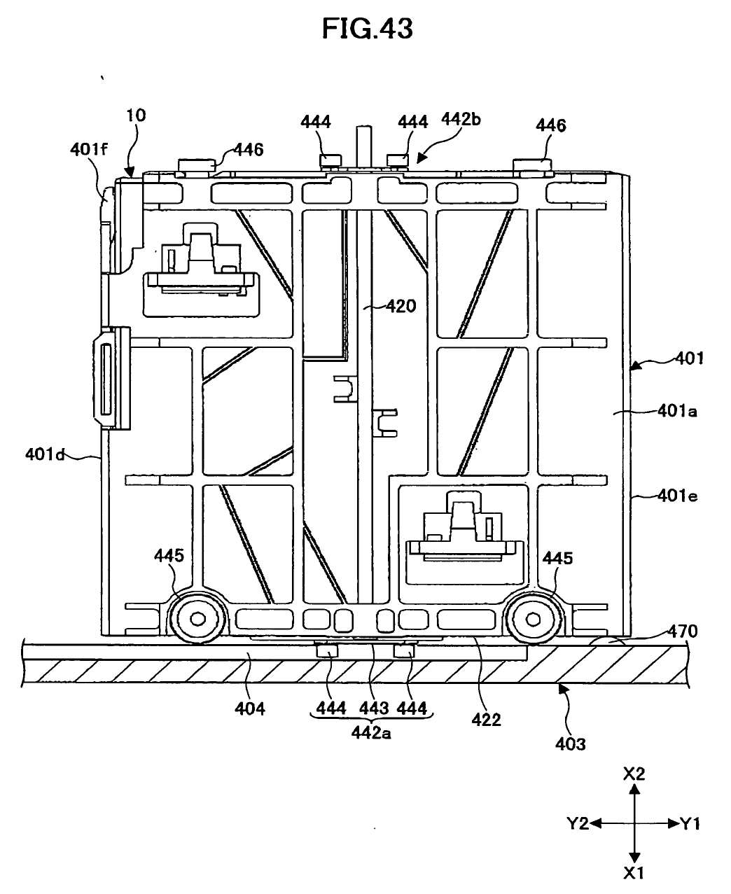

FIG. 43 is a plan view showing a state immediately before the lowering operation of the tape cartridge container 401. As shown in FIG. 43, the first protrusion 470 enters the opening 422 of the tape cartridge container 401 immediately before the lowering movement of the tape cartridge container 401 along the outer periphery of the pulley 386Y1. Accordingly, the end face of the tape cartridge 10 (end face toward the opening 422 of the tape cartridge container 401) abuts and slides over the first protrusion 470, to thereby force the tape cartridge 10 into the cartridge storage space 405 of the tape cartridge container 401.

Therefore, in a case where an end portion of the tape cartridge 10 protrudes from the opening 422 of the tape cartridge container 401, the tape cartridge 10 is forced back into the cartridge storage space 405 by having the end portion abut and slide over the first protrusion 470. Then, the concave latching section 460 of the tape cartridge 10 is moved toward the engaging part 401f₂ of the latching section 401f such that the tape cartridge 10 is in a latched state having the engaging part 401f₂ of the latching section 401f abutted against the edge part 462 of the concave latching section 460. As a result, the tape cartridge 10 returns to the state of being stored in the predetermined storage position in the cartridge storage space 405. Accordingly, the end portion of the tape cartridge 10 can be inhibited or prevented from contacting the lateral plate 403 in the process of lowering the tape cartridge container 401 along the outer periphery of the pulley 386Y1, and the tape cartridge container 401 can be transported smoothly.

Furthermore, in the operation of raising the tape cartridge container 401 along the pulley 386Y2, the second protrusion 472 enters the opening 422 of the tape cartridge container 401 immediately before the raising movement of the tape cartridge container 401 along the outer periphery of the pulley 386Y2. Accordingly, the end face of the tape cartridge 10 (end face toward the opening 422 of the tape cartridge container 401) abuts and slides over the second protrusion 472, to thereby force the tape cartridge 10 into the cartridge storage space 405 of the tape cartridge container 401.

Therefore, in a case where an end portion of the tape cartridge 10 protrudes from the opening 422 of the tape cartridge container 401, the tape cartridge 10 is forced back into the cartridge storage space 405 by having the end portion abut and slide over the second protrusion 472. Then, the concave latching section 460 of the tape cartridge 10 is moved toward the engaging part 401f₂ of the latching section 401f such that the tape cartridge 10 is in a latched state having the engaging part 401f₂ of the latching section 401f abutted against the edge part 462 of the concave latching section 460. As a result, the tape cartridge 10 returns to the state of being stored in the predetermined storage position in the cartridge storage space 405.

Accordingly, with the above-described embodiment of the present invention, by providing a tape cartridge autoloader having a latching part for latching a tape cartridge to a predetermined storage position inside a tape cartridge container, and a cartridge recovery part for returning the tape cartridge to the latched state in the predetermined storage position when the tape cartridge protrudes from an opening of the tape cartridge container, the tape cartridge can be stored in a loosely latched state so that the tape cartridge can be easily retrieved from the tape cartridge container. Furthermore, the tape cartridge can be returned to the predetermined storage position by the cartridge recovery part when the tape cartridge protrudes from the tape cartridge container during transportation of the tape cartridge container. Accordingly, smooth transportation of the tape cartridge container can be achieved.

Furthermore, since the cartridge recovery part is situated at a position immediately before the transportation of the tape cartridge container changes from a horizontal movement to a vertical movement, the tape cartridge can be inhibited or prevented from protruding from the opening of the tape cartridge container when the tape cartridge container is transported vertically. Accordingly, the tape cartridge can be inhibited or prevented from contacting the guide groove formed in the lateral plate of the tape cartridge transport magazine. Thereby, smooth transportation of the tape cartridge container can be achieved.

The present application is based on Japanese Priority Application No. 2005-269197 filed on Sep. 15, 2005, with the Japanese Patent Office, the entire contents of which are hereby incorporated by reference.

While the particular autoloader 100 as herein shown and disclosed in detail is fully capable of obtaining the objects and providing the advantages herein before stated, it is to be understood that it is merely illustrative of various embodiments of the invention. No limitations are intended to the details of construction or design herein shown other than as described in the appended claims.

What is claimed is:

1. A media cartridge autoloader for transporting a media cartridge container to a predetermined media cartridge retrieval position, retrieving a media cartridge stored in the media cartridge container from an opening of the media cartridge container, and reading/writing data from or to the media cartridge, the media cartridge autoloader comprising:
a latching part for latching the media cartridge in a predetermined storage position inside the media cartridge container; and
a protrusion for returning the media cartridge to the latched state in the predetermined storage position when the media cartridge protrudes from the opening of the media cartridge container.

2. The media cartridge autoloader as claimed in claim 1, wherein the latching part includes an engaging part that engages with a concave section of the media cartridge, wherein when retrieving the media cartridge from the predetermined storage position of the media cartridge container, the latching part is configured to release the latched state of the media cartridge by elastically deforming in a direction to which the engaging part separates from the concave section.

3. The media cartridge autoloader as claimed in claim 1, further comprising:
a lateral plate including a transportation path through which the media cartridge container is transported;
wherein the protrusion is configured to return the media cartridge to the latched state in the predetermined storage position when the media cartridge protrudes from the opening of the media cartridge container when transported along the transportation path.

4. The media cartridge autoloader as claimed in claim 3, wherein the protrusion is situated at a position immediately before the transportation of the media cartridge container changes from a horizontal movement to a vertical movement.

5. A media cartridge transport magazine for movably storing a media cartridge in a media cartridge autoloader, the media cartridge autoloader including a media drive that receives a media cartridge and a media cartridge picker that moves the media cartridge relative to the media drive and the media cartridge transport magazine, the media cartridge transport magazine comprising:
a media cartridge container that receives the media cartridge through an opening in the media cartridge container;
a container positioner that positions the container relative to the media cartridge picker;
a latching part for latching the media cartridge in a predetermined storage position inside the media cartridge container; and
a first protrusion that exerts a force on the media cartridge to return the media cartridge to the predetermined storage position when the media cartridge protrudes from the opening of the media cartridge container.

6. The media cartridge transport magazine as claimed in claim 5,
wherein the first protrusion remains stationary during movement of the media cartridge container by the container positioner.

7. The media cartridge transport magazine as claimed in claim 5,
wherein the first protrusion at least partially extends into the opening of the media cartridge container when the media cartridge container moves past the first protrusion.

8. The media cartridge transport magazine as claimed in claim 5,
wherein the first protrusion is substantially hemispherical-shaped.

9. The media cartridge transport magazine as claimed in claim 5,
further comprising a second protrusion that exerts a force on the media cartridge to return the media cartridge to the predetermined storage position when the media cartridge protrudes from the opening of the media cartridge container, the second protrusion having a different configuration than the first protrusion.

10. The media cartridge transport magazine as claimed in claim 5S
wherein the container positioner moves the media cartridge container along a transportation path, and wherein the first protrusion is positioned along the transportation path of the media cartridge container.

11. The media cartridge transport magazine as claimed in claim 5,
wherein the first protrusion does not exert a force on the media cartridge when the media cartridge is in the predetermined storage position.

12. The media cartridge transport magazine as claimed in claim 5,
wherein the latching part engages the media cartridge to releasably retain the media cartridge in the predetermined storage position.

13. The media cartridge transport magazine as claimed in claim 5,
wherein the latching part elastically deforms to release the media cartridge when the cartridge picker commences movement of the media cartridge from the media cartridge container.

14. The media cartridge autoloader as claimed in claim 5,
wherein the first protrusion is positioned to exert a force on the media cartridge that protrudes from the media cartridge container approximately when the movement of the media cartridge container changes between a horizontal movement and a vertical movement.

15. The media cartridge autoloader as claimed in claim 5,
wherein the first protrusion is positioned to exert a force on the media cartridge that protrudes from the media cartridge container approximately after the movement of the media cartridge container changes between a vertical movement and a horizontal movement.

16. A method for operating a media cartridge autoloader including a media cartridge transport magazine that movably stores a media cartridge therein, a media drive that receives the media cartridge, and a media picker that moves the media cartridge relative to the media drive and the media cartridge transport magazine, the method comprising the steps of:
receiving the media cartridge through an opening in a media cartridge container of the media cartridge transport magazine;
positioning the media cartridge container relative to the media cartridge picker;
and
exerting a force on the media cartridge to position the media cartridge in a predetermined storage position when the media cartridge protrudes from the opening of the media cartridge container during positioning of the media cartridge container relative to the media cartridge picker.

17. The method as claimed in claim 16 further comprising the step of latching the media cartridge in the predetermined storage position substantially inside the media cartridge container.

18. The method as claimed in claim 16 wherein the step of exerting includes exerting a force on the media cartridge with a protrusion that is positioned outside of the media cartridge container.
